(19) United States
(12) Patent Application Publication
(10) Pub. No.: US 2013/0128320 A1
(43) Pub. Date: May 23, 2013

(54) IMAGE FORMING APPARATUS HAVING REPLY MAIL GENERATING FUNCTION AND METHOD FOR CONTROLLING THE SAME

(71) Applicant: CANON KABUSHIKI KAISHA, Tokyo (JP)

(72) Inventor: Shinji Fujikawa, Yokohama-shi (JP)

(73) Assignee: CANON KABUSHIKI KAISHA, Tokyo (JP)

(21) Appl. No.: 13/742,099

(22) Filed: Jan. 15, 2013

Related U.S. Application Data
(62) Division of application No. 12/338,756, filed on Dec. 18, 2008.

(30) Foreign Application Priority Data
Dec. 20, 2007 (JP) 2007-328713

(51) Int. Cl. H04N 1/00

(52) U.S. Cl. CPC H04N 1/00209
USPC 358/402

(57) ABSTRACT

An image forming apparatus includes units, such as mail reception, mail management, reading, detection, device identifier comparing, retrieval, printing, and mail attaching and sending. The mail management unit stores received electronic mail. The detection unit detects electronic mail identification information and a device identifier contained in document image data generated from a document image. The detected device identifier is compared with the image forming apparatus device identifier. If the detected device identifier corresponds to the image forming apparatus device identifier, then the retrieval unit searches the stored electronic mail in the mail management unit for an electronic mail corresponding to the electronic mail identification information. The printing unit performs printing of the electronic mail stored in the mail management unit. If the detected device identifier does not correspond, an electronic mail containing the read document image data is sent to an image forming apparatus having the detected device identifier.

### CROSS REFERENCE TO RELATED APPLICATIONS

The present application is a divisional of U.S. patent application Ser. No. 12/338,756, filed on Dec. 18, 2008, which claims priority from Japanese Patent Application No. 2007-328713, filed Dec. 20, 2007, all of which are hereby incorporated by reference herein in their entirety.

### BACKGROUND OF THE INVENTION

1. Field of the Invention

The present invention relates to an image forming apparatus configured to generate a mail replying to a received mail and a method for controlling the image forming apparatus.

2. Description of the Related Art

Popularization of personal computers (PCs) and network services (e.g., Internet and Intranet) enables many users to communicate with each other via electronic mails. There are various types of mail softwares (e.g., Microsoft Outlook Express provided by Microsoft Corporation) operable on PCs of users who send and receive information. Electronic mails capable of easily and quickly sending text data together with other electronic data (e.g., images) are one of an effective business support tools widely used.

As devices other than PCs, network multifunction peripherals (hereinafter, referred to as “multifunction peripherals”) can send and receive electronic mails containing various data via networks. Representative functions of the multifunction peripherals are a “document image mail sending function” and an “electronic mail printout function.” According to the “document image mail sending function”, a multifunction peripheral can scan a paper document, generate image data of the paper document, and transmit an electronic mail with attached image data to a designated mail address. According to the “electronic mail printout function”, a multifunction peripheral can receive an electronic mail and print a mail body (text) or image data attached to the received mail.

As the multifunction peripherals enable users to easily send, receive, and output (print) electronic mails, the multifunction peripherals are widely used in various fields of business. For example, a workflow using an application form to be approved by a supervisor has been conventionally performed in the following manner.

1) An applicant fills out an application form (writes application contents on a paper by hand) and forwards the written application to an approver by hand or using postal service.
2) The approver receives the application form from the applicant and performs an approval work on the application form. The approval work includes writing a result with respect to approval/rejection determination, signing approver's name, and putting an approver's seal on the application form.
3) The approver returns the completed application form to the applicant by hand or using postal service.

However, if an applicant and an approver can use multifunction peripherals having the “document image mail sending function” and the “electronic mail printout function”, the above-described processes 1) to 3) can be changed in the following manner.

a) An applicant fills out an application form (writes application contents on a paper by hand) and sends an electronic mail containing image data of the written application form to an approver using the “document image mail sending function” of the multifunction peripheral, while designating a job-related person in the “Carbon Copy (Cc)” field of the mail.
b) The approver receives and outputs (prints) an applicant's mail using the “electronic mail printout function” of the multifunction peripheral. The approver performs an approval work on the printed application form. Namely, the approver writes an approval/rejection determination result, signs approver's name, and puts an approver's seal on the application form.
c) The approver returns an electronic mail including the application form completed by the approver to the applicant using the “document image mail sending function” of the multifunction peripheral, while designating the job-related person in the “Cc” field of the mail.

When electronic mails are used, an applicant and an approver need not to send and receive an application form by hand or using postal service. When a job-related person (i.e., a person related to the application procedure performed between the applicant and the approver) is designated in the “To” or “Cc” field of an electronic mail, the job-related person can check the current status of the application procedure performed between the applicant and the approver.

However, in the above-described process c), the approver may mistakenly return an electronic mail to a person other than the applicant. The approver may input a wrong address or forget to input the address of the job-related person in the “Cc” field. The following techniques can solve such problems.

First, the technique discussed in Japanese Patent Application Laid-Open No. 6-149505 enables a user to print designated item(s) of mail header information together with the mail body (text) and attached file(s). When this technique is used, mail header information (address, subject, etc.) designated in “Reply-to” and “Cc” fields can be printed in the header of a printed document of the mail body or an attached file.

Second, the technique discussed in Japanese Patent Application Laid-Open No. 2005-244411 includes scanning a document to obtain necessary image data (e.g., mail address, subject, and text), performing OCR processing to read necessary information from the document image data, and setting the read information to an electric mail. When this technique is used, it is unnecessary to manually input necessary information (e.g., mail address, subject, and text) via an operation panel of the multifunction peripheral because the necessary information can be scanned from the document.

If the above-described first and second techniques are combined, the application/approval task workflow can be modified in the following manner.

x) An applicant fills out an application form (writes application contents on a paper by hand) and sends an electronic mail containing image data of the written application form to an approver using the “document image mail sending function” of the multifunction peripheral, while designating a job-related person in the “Cc” field of the mail.
y) The approver receives and outputs (prints) an applicant's mail together with the mail header information described in the “Reply-to”, “Cc”, and “Subject” using the “electronic mail printout function” of the multifunction peripheral. The approver performs an approval work on the printed application form. Namely, the approver writes an approval/rejection determination result, signs approver's name, and puts an approver's seal on the application form.
z) The approver returns an electronic mail including the application form completed by the approver to the applicant using the “document image mail sending function” of the multifunction peripheral, while setting the information scanned from the “Reply-to”, “Cc”, and “Subject” fields of the original mail and read by OCR processing in the return mail.

In this manner, combining the above-described first and second techniques can reduce the burden placed on the approver and prevent the approver from erroneously inputting an address or forgetting to input the address when the approver returns an electronic mail to the application.

However, the following problems may arise in the above-described application/approval task workflow using electronic mails.

The first problem relates to the amount of mail header information to be output. According to the above-mentioned application/approval task workflow, the approver outputs (prints) mail header information described in the “Reply-to”, “Cc”, and “Subject” together with an application form.

However, if two or more mail addresses are designated in the “Cc” field, the amount of header information printed in the above-described process y) increases correspondingly and a wide print area is required to print the increased information. In general, the application form has a regulated size according to the type of application. The space available for printing header information is limited. As a result, when the information amount is excessively large, it is difficult to print all necessary information in the designated area of a paper. In this case, information not printed on the first page is printed on an additional page. On the other hand, if the rest of the header information is not output (printed), insufficient information is set in a mail sent by the approver in the above-described process z).

In other words, it is desired to adequately suppress the amount of information to be printed even if the amount of mail header information increases or decreases. However, it is difficult for the above-described conventional technique.

The second problem relates to setting of a reply mail when the approver returns a mail in response to a mail sent by the applicant.

A method for managing a plurality of electronic mails while associating them is conventionally available. According to this management method, when a reply mail is sent in response to a received mail, the received mail (original mail) is referred to as a parent mail and the reply mail is referred to as a child mail.

In the above-described application/approval task workflow, the mail sent from the applicant to the approver in the process x) is a parent mail and the mail returned from the approver to the applicant in the process z) is a child mail.

According to “3.6.4. Identification fields” of RFC2822 “Internet Message Format”, header information of a child mail is required to describe information indicating the relevancy to its parent mail. More specifically, the following two points d) and e) need to be satisfied.

d) Information described in an “In-Reply-To:” field of the header of a child mail is the content of “Message-ID:” field of a parent message (parent mail).
e) Information described in a “References:” field, if provided, of the header of a child mail is the content of the “References:” field of a parent message (parent mail) and the content of the “Message-ID:” field of the parent message (parent mail) described in this order.

The mail software operable on a PC is generally configured to generate a reply mail according to the RFC regulations and display a parent-child relationship among mails sent and received.

FIG. 1 illustrates an example mail parent-child relationship realized by the mail software.

FIG. 1 illustrates an example list 1000 indicating a parent-child relationship among mails sent and received. The example parent-child relationship illustrated in FIG. 1 includes the contents (e.g., date and time sent, subject, and sender) of each mail summarized in a line based on mail header information (one mail=one line). The list 1000 includes parent mails 1001a, 1002a, and 1003a and child mails 1001b, 1002b, and 1003b. The illustrated parent-child relationship expresses each child mail following its parent mail according to an indent display method.

For example, the parent mail 1001a and the child mail 1001b having the same subject are in a parent-child relationship. Similarly, the parent mail 1003a and the child mail 1003b having the same subject are in a parent-child relationship. Senders of the parent mails 1001a and 1003a are identical. Similarly, senders of the child mails 1001b and 1003b are identical. The parent-child relationship is header information described according to the above-described RFC regulations.

In the above-described application/approval task workflow, when the mail sent from applicant to the approver in the process x) is defined as a parent mail and the mail returned from the approver to the applicant in the process z) is defined as a child mail, the relevancy between the applicant's mail and the approver's mail can be easily understood as indicated in the list 1000. This mail management method is generally referred to as a “thread display” or a “tree display” of the mail software.

A comparative list 1010 is different from the list 1000 in that a parent-child relationship based on mail header information is not defined according to the RFC regulations. Parent mails 1011a, 1012a, and 1013a and child mails 1011b, 1012b, and 1013b are relevant to each other. However, when all the mails are arranged in order of date and time sent, the parent mail 1013a and the corresponding child mail 1013b are located far from each other because no parent-child relationship is defined between them. Furthermore, the child mail 1012b and the parent mail 1013a located next to each other are not relevant to each other. In this manner, if a parent-child relationship defined according to the RFC regulations is not described as header information, the relationship among a plurality of mails is not clearly understood.

The parent-child relationship can be supported in the application/approval task workflow using a conventional technique, in the following manner.

More specifically, in the process y) of the above-described workflow, the approver prints information of the “Message-ID” and “References” fields (part of mail header information) on an application form.

Then, in the process z) of the above-described workflow, the approver sets information read by the OCR processing in the “In-Reply-To” and “References” fields of a reply mail.

However, similar to the first problem, this method may induce a problem relating to a print area. More specifically, if numerous unspecified Message-IDs are described in the “References” field, the amount of information increases significantly and a large print area is required.

As another method, the following method can be used.

In the process z) of the above-described workflow, the approver displays a list of received mails on an operation panel of the multifunction peripheral and the approver selects an original applicant's mail from the list and generates a child mail corresponding to the selected mail.

According to this method, it is unnecessary to print “Message-ID” and “References” on an application form beforehand. The problem relating to a print area does not arise. However, the method may induce another problem.

In general, each approver is required to process many applications sent from numerous applicants. Furthermore, an approver may be in charge of approval processing in a plurality types of application tasks. An applicant may submit the same type of applications several times. As a result, an approver tends to receive a wide variety of mails from numerous applicants.

If the approver selects an original applicant's mail in the process z) of the above-described workflow, the approver needs to find the correct original mail while excluding numerous mails received from other applicants. In this case, the approver may erroneously select another application mail sent from the same person or select a similar application mail sent from another applicant.

Further, if the above-described process z) is performed using a multifunction peripheral different from the multifunction peripheral used by the approver in the process y) of the above-described workflow, no original mail received from the applicant is present.

### SUMMARY OF THE INVENTION

According to an aspect of the present invention, an image forming apparatus includes a mail reception unit configured to access a mail server based on designated mail account information and perform reception of an electronic mail, a mail management unit configured to store the electronic mail received by the mail reception unit in a readable state, a reading unit configured to read a document image and generate document image data, a detection unit configured to detect electronic mail identification information and a device identifier contained in the document image data, a device identifier comparing unit configured to compare the device identifier detected by the detection unit with the device identifier allocated to the image forming apparatus, a retrieval unit configured to search the stored electronic mail in the mail management unit for an electronic mail corresponding to the electronic mail identification information if the device identifier detected by the detection unit corresponds to the device identifier allocated to the image forming apparatus, a printing unit configured to perform printing of the electronic mail stored in the mail management unit, and a mail attaching and sending unit configured to send an electronic mail containing the read document image data to an image forming apparatus having the detected device identifier if the device identifier detected by the detection unit does not correspond to the device identifier allocated to the image forming apparatus.

According to another aspect of the present invention, an image forming apparatus includes a device identifier serving as information that can identify the image forming apparatus, a mail reception unit configured to access a mail server based on designated mail account information and perform reception of an electronic mail, a mail management unit configured to store the electronic mail received by the mail reception unit in a readable state, a reading unit configured to read a document image and generate document image data, a detection unit configured to detect electronic mail identification information or a device identifier contained in the document image data, a retrieval unit configured to search the mail management unit for the electronic mail corresponding to the electronic mail identification information, and a printing unit configured to perform printing of the electronic mail stored in the mail management unit.

According to exemplary embodiments of the present invention, a reply mail is generated by scanning a paper on which a Message-ID of an original mail is printed. Therefore, the amount of mail information on a printed document is small. Furthermore, the reply mail is generated by automatically identifying the original mail based on the read Message-ID. Therefore, mail selection errors in sending reply mails responding to original mails can be eliminated.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments and features of the invention and, together with the description, serve to explain at least some of the principles of the invention.

FIG. 1 illustrates an example display of a mail parent-child relationship realized by general mail software.

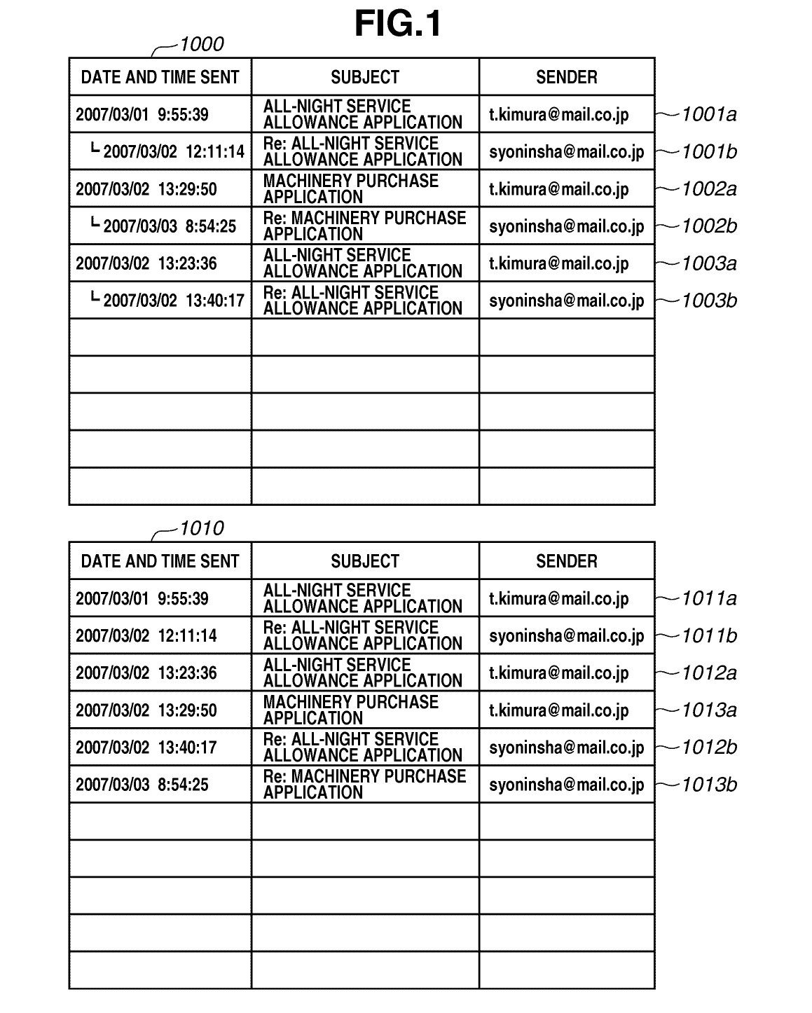

FIG. 2 illustrates an exemplary configuration of a business workflow system according to an exemplary embodiment of the present invention, which includes a multifunction peripheral configured to perform communications with other devices with electronic mails.

FIG. 3 is a block diagram illustrating a hardware configuration of a multifunction peripheral.

FIG. 4 illustrates an appearance of an example multifunction peripheral.

FIG. 5 illustrates an example of a software configuration of a multifunction peripheral and a data storage unit according to a first exemplary embodiment.

FIG. 6 illustrates an example of an operation unit.

FIG. 7 illustrates an example of an application task workflow based on mail sending operations according to the first exemplary embodiment.

FIG. 8 illustrates an example of a mail sending operation screen.

FIG. 9 illustrates an example of a sending setting screen.

FIG. 10 is a flowchart illustrating example mail sending processing.

FIG. 11 illustrates an example of image data of an application form.

FIG. 12 illustrates an example of data of an application form (mail body).

FIG. 13 illustrates an example of a mail reception operation screen.

FIG. 14 is a flowchart illustrating an example of a received mail display processing.

FIG. 15 is a flowchart illustrating an example of a mail reception processing.

FIG. 16 illustrates an example of a mail reception error notification screen.

FIG. 17 is a flowchart illustrating an example of a reception mail print processing.

FIG. 18 illustrates an example of a print object selection screen.

FIG. 19 illustrates an example of a print image including image data of an application form and image data of a two-dimensional bar code.

FIG. 20 illustrates an example of a print image including a mail body and image data of a two-dimensional bar code.

FIG. 21 illustrates an application form completed by an approver.

FIG. 22 illustrates an application form (mail body) completed by an approver.

FIG. 23 is a flowchart illustrating an example of a mail auto-reply processing.

FIG. 24 illustrates an example of a software configuration of a multifunction peripheral and a data storage unit according to a second exemplary embodiment.

FIG. 25 illustrates an example of a application task workflow based on mail sending operations according to the second exemplary embodiment.

FIG. 26 is a flowchart illustrating an example of a reception mail print processing according to the second exemplary embodiment.

FIG. 27 is a flowchart illustrating an example of a mail auto-reply processing according to the second exemplary embodiment.

FIG. 28 is a flowchart illustrating an example of a device transfer mail reception/sending processing.

### DETAILED DESCRIPTION OF THE EMBODIMENTS

The following description of exemplary embodiments is illustrative in nature and is in no way intended to limit the invention, its application, or uses. It is noted that throughout the specification, similar reference numerals and letters refer to similar items in the following figures, and thus, once an item is described in one figure, it may not be discussed for following figures. Exemplary embodiments will be described in detail below with reference to the drawings.

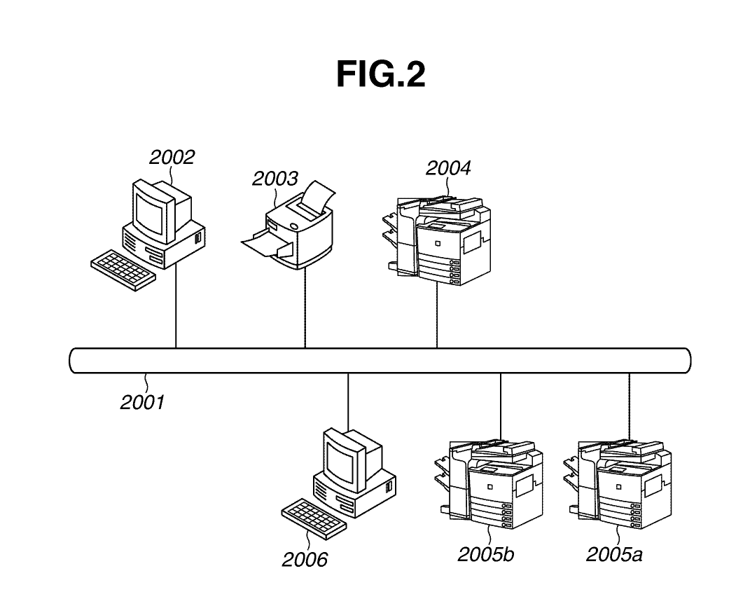

A first exemplary embodiment of the present invention will be described below referring to the drawings. FIG. 2 illustrates an exemplary configuration of a business workflow system according to an exemplary embodiment of the present invention, which includes a multifunction peripheral configured to perform communications with other devices with electronic mails.

A network 2001 is Ethernet or Internet. A computer 2002 enables an applicant to transmit or receive an electronic mail via the network 2001. A printer 2003 receives a print instruction from the computer 2002 and performs print processing. A multifunction peripheral 2004 enables an applicant to scan an application form and transmit an electronic mail with the scanned application form to an approver. The approver can use two multifunction peripherals 2005a and 2005b to receive a mail from the applicant and print an application form contained in the received mail, and scan the application form completed by the approver and send a reply mail containing the scanned application form to the applicant.

A job-related person can use a computer 2006 to receive the applicant's mail if an address of the job-related person is designated in a “Cc” field of the applicant's mail sent to the approver.

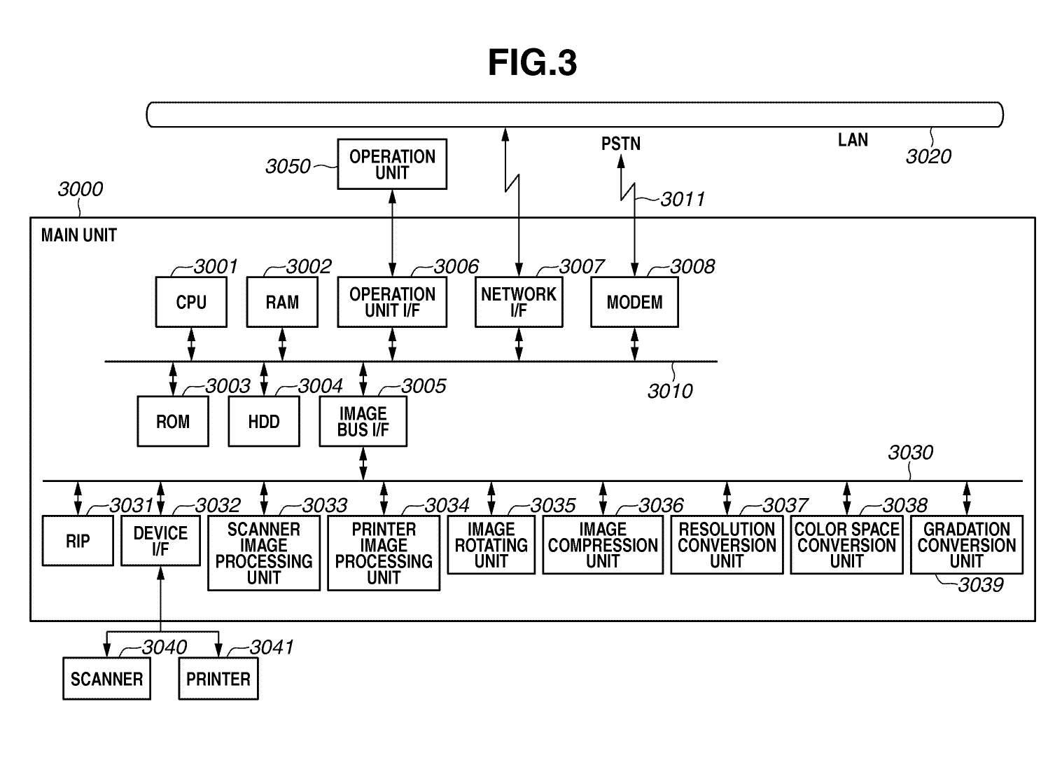

FIG. 3 is a block diagram illustrating an exemplary hardware configuration for the multifunction peripherals 2004, 2005a, and 2005b illustrated in FIG. 2.

A main unit 3000 is a controller configured to perform input/output of document data, image information, and device information. The main unit 3000 is connected to a scanner 3040 serving as an image input device and a printer 3041 serving as an image output device, to realize scanning and printing functions. The main unit 3000 is connected to an external device (such as a mail server) via a local area network (LAN) 3020, to realize sending/reception of data. The main unit 3000 is connected to a public telephone line (PSTN) 3011 to realize a FAX function. The main unit 3000 is connected to an operation unit 3050 serving as an interface configured to enable a user to use the above-described functions.

A central processing unit (CPU) 3001 is a controller controlling various operations of the main unit 3000. A random access memory (RAM) 3002 is a system work memory operable for the CPU 3001, or an image memory capable of temporarily storing image data. A read only memory (ROM) 3003 is a booth ROM storing a system boot program. A hard disk drive (HDD) 3004 stores system software, image data, attribute data, and other user data. The system software stored in the HDD 3004 can realize mail printing, mail generation, two-dimensional bar code generation, and analysis processing. The HDD 3004 stores received mail data.

An operation unit interface (I/F) 3006 serves as an interface unit configured to cause the main unit 3000 to perform communication with the operation unit (UI) 3050. The operation unit I/F 3006 outputs display data to the operation unit 3050 and sends information entered by a system user to the CPU 3001. The operation unit 3050 can display a received mail and a sending mail setting screen.

A network interface (I/F) 3007 is connected to the LAN 3020 to cause the main unit 3000 to input/output information from/to an external device (e.g., another multifunction peripheral or PC) accessible via the LAN 3020. For example, the network communication protocol supported by the system is TCP/IP. The network I/F 3007 can perform communication with an external device according to the TCP/IP communication protocol.

A modem 3008 is connected to the public telephone line 3011 to enable the multifunction peripheral (having the FAX function) to perform input/output of image information from/to an external facsimile apparatus.

An image bus I/F 3005 is a bus bridge capable of high-speed image data transfer from a system bus 3010 to an image bus 3030 or vice versa and converting a data structure of the transferred image data. The image bus 3030 may be a Peripheral Component Interconnect (PCI) bus or IEEE1394.

The image bus 3030 connects the following devices. A raster image processor (RIP) 3031 receives a PDL code from a PC connected to the LAN 3020 and rasterizes the received PDL code into a bitmap image. A device I/F unit 3032 connects the scanner 3040 (image input device) and the printer 3041 (image output device) to the main unit (controller) 3000 and performs synchronous/asynchronous conversion of image data.

A scanner image processing unit 3033 performs correction, modification, and editing processing on input image data. Furthermore, the scanner image processing unit 3033 determines whether an input image is a color document or a monochrome document based on a color saturation signal of the image. The scanner image processing unit 3033 stores the determined result.

A printer image processing unit 3034 performs correction, modification, and editing processing on output image data. An image rotating unit 3035 rotates an image read by the scanner 3040 in association with the scanner image processing unit 3033 and stores the rotated image on a memory. Furthermore, the image rotating unit 3035 rotates an image on the memory. The image rotating unit 3035 rotates and outputs an image on the memory in association with the printer image processing unit 3034.

A resolution conversion unit 3037 performs resolution conversion processing on an image and stores the processed image on the memory. A color space conversion unit 3038 converts, for example, a YUV image into a Lab image based on matrix calculation and stores the converted image on the memory. A gradation conversion unit 3039 converts an 8-bit (=256 gradations) image on the memory into a 1-bit (=2 gradations) image by performing error diffusion processing and stores the converted image on the memory. An image compression unit 3036 performs JPEG processing on multi-valued image data and performs JBIG, MMR, MR, and MH compression/expansion processing on binary image data.

The image rotating unit 3035, the resolution conversion unit 3037, the color space conversion unit 3038, the gradation conversion unit 3039, and the image compression unit 3036 can cooperatively operate and perform, for example, the image rotation processing and the resolution conversion processing without accessing the memory.

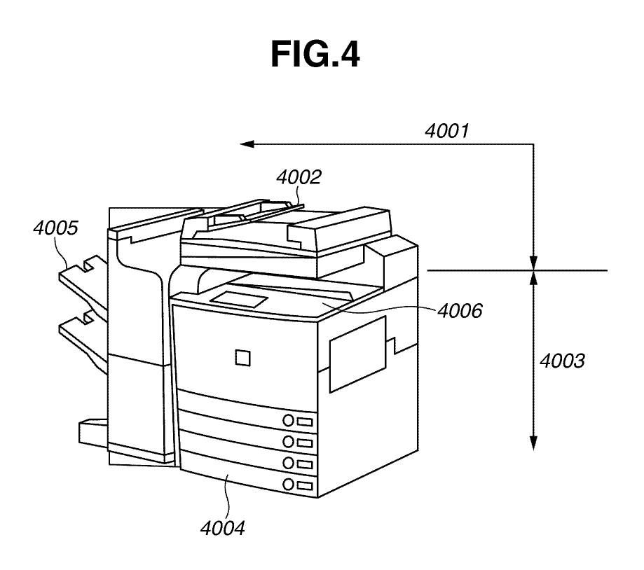

FIG. 4 illustrates an example of a multifunction peripheral according to an exemplary embodiment of the present invention, which performs a plurality of functions including a copy function, a network (e.g., electronic mail or FAX) function, a printer function, and a document management function.

A scanner unit 4001 serving as an image input device irradiates a paper (document) with light and causes a charge-coupled device (CCD) line sensor performing scanning to convert a scanned image into an electric signal representing raster image data. A system user sets document sheets on a tray of a document feeder 4002 and instructs starting a reading operation via an operation unit 4006. In response to the user's instruction, the CPU 3001 of the main unit (controller) 3000 illustrated in FIG. 3 causes the scanner 3040 to perform a reading operation while causing the document feeder 4002 to feed the document sheets one after another.

A printer unit 4003 (serving as an image output device) prints an image on a recording sheet based on raster image data, for example, according to an electrophotographic method using a photosensitive drum or a photosensitive belt or an inkjet method using a micro nozzle array capable of discharging ink droplets to directly print an image on the sheet.

The printer unit 4003 starts print processing in response to an instruction received from the CPU 3001 of the main unit (controller) 3000. The printer unit 4003 includes a plurality of sheet cassettes 4004, which can store various recording sheets to enable a user to designate a desired recording sheet selected from two or more types of sheets different in size or orientation. A discharge tray 4005 receives printed sheets. The CPU 3001 of the main unit (controller) can cause the printer unit 4003 to perform sort or staple processing.

The operation unit 4006 displays a received mail on its display unit.

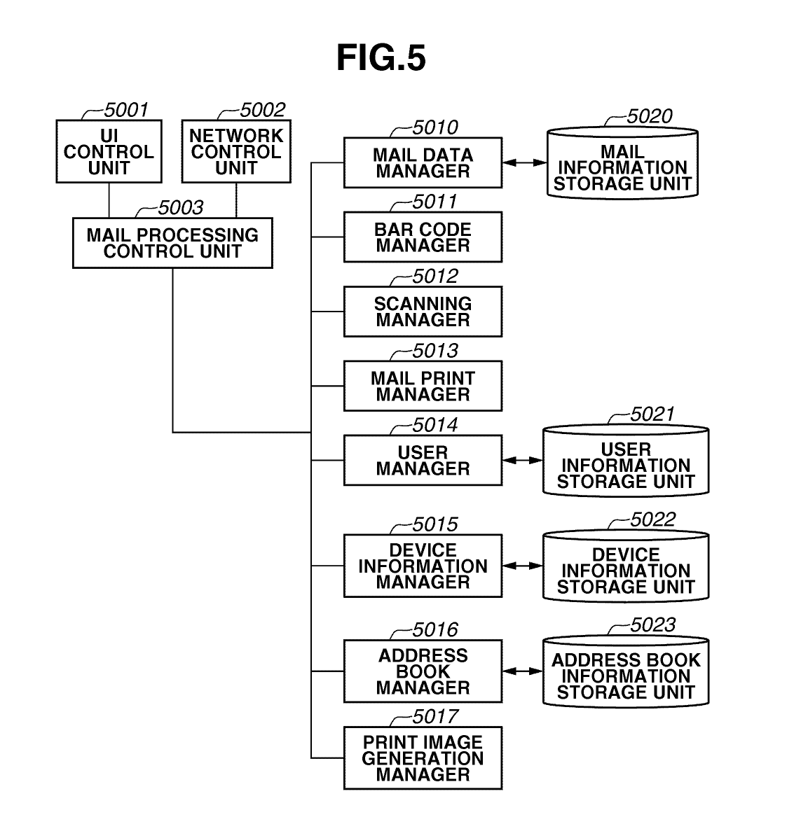

FIG. 5 illustrates an example of a software configuration of a multifunction peripheral and a data storage unit according to a first exemplary embodiment, which can be stored in the HDD 3004 illustrated in FIG. 3.

A user interface (UI) control unit 5001, configured to control the operation unit 4006, performs processing for transmitting a user's instruction to a mail processing control unit 5003 (i.e., a subordinate unit) or displaying, on a UI screen, information received from the mail processing control unit 5003. A network control unit 5002 receives a mail from a mail server or sends a mail to the mail server according to an instruction from the mail processing control unit 5003.

The mail processing control unit 5003 receives an instruction from the UI control unit 5001 or the network control unit 5002 and performs mail reception/sending processing. Furthermore, the mail processing control unit 5003 instructs a subordinate module to store received mail data and perform retrieval processing, document scanning processing, and mail print processing.

A mail data manager 5010 stores received mail data and an attached file to the mail information storage unit 5020 according to an instruction from the mail control unit 5003. The mail data manager 5010 performs mail data management for storing mail data and searching for an attached file.

A bar code manager 5011 performs bar-code encoding processing for generating image data of a two-dimensional bar-code based on designated information and bar-code decoding processing for analyzing a read two-dimensional bar code image to reconstruct the original data.

A scanning manager 5012 causes the scanner 3040 to perform document reading processing and generates electronic data of a scanned image.

A mail print manager 5013 causes the printer 3041 to print a composite image including a header and a body (text) of a mail, electronic data attached to the mail, and bar code data generated by the bar code manager 5011.

A user manager 5014 authenticates a user of software based on user information stored in a user information storage unit 5021 and acquires mail account information (i.e., information required to access a mail server) from the user information storage unit 5021.

A device information manager 5015 acquires device-related information (e.g., a mail address or mail account information allocated to each device) stored in a device information storage unit 5022.

An address book manager 5016 acquires a mail address from an address book information storage unit 5023, which stores mail address information of an outgoing mail. Furthermore, the address book manager 5016 registers a new mail address to the address book information storage unit 5023. When a user designates an address of an outgoing sending mail, the user can refer to the address book instead of manually inputting address information.

A print image generation manager 5017 performs image synthesis processing for generating print data including a two-dimensional bar code image generated by the bar code manager 5011 combined with text/file data when the printer unit 4003 prints a text of a mail or a file attached to the mail.

The mail information storage unit 5020, the user information storage unit 5021, the device information storage unit 5022, and the address book information storage unit 5023 are data area string information, such as a text file describing data contents or a data file stored in a database. Data reading processing is feasible using these information storage units. A user can retrieve and acquire specific data by designating an identifier identifying the data. A user can acquire a plurality of pieces of data that satisfies predetermined conditions. A user can add new data and change/delete the stored data by designating an identifier.

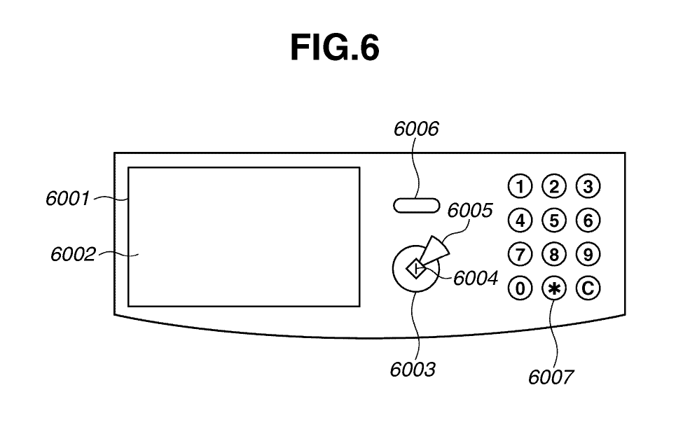

FIG. 6 illustrates an exemplary configuration of the operation unit 3050. A liquid crystal display (LCD) unit 6001 includes a touch panel sheet 6002 laminated on the LCD, which displays a system operation screen and softkeys. When a user presses a displayed softkey, the LCD unit 6001 sends positional information of the pressed key to the CPU 3001 of the main unit (controller). A start key 6003 enables a user to start a document image reading operation and includes a light-emitting diode (LED) 6004 located at the center thereof. The LED 6004 is a two-color (green and red) LED indicating a usable/unusable state of the start key 6003. A user can press a stop key 6005 to terminate a currently running operation. A user can initialize settings via the operation unit 3050 by pressing a reset key 6006. A numeric keypad 6007 enables a user to input a FAX number or the number of copy sheets.

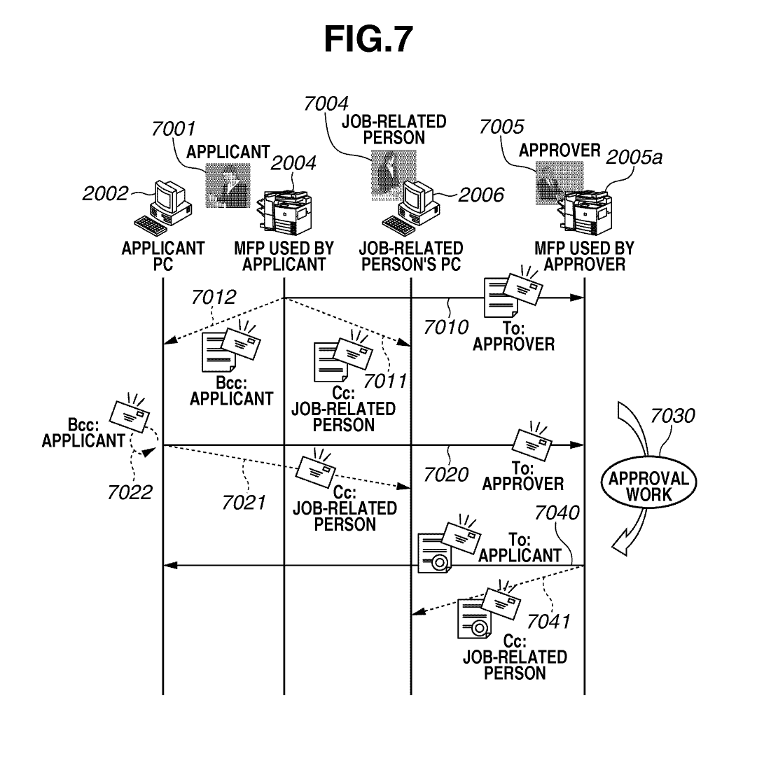

FIG. 7 illustrates a general procedure in an application task workflow according to the first exemplary embodiment of the present invention, in which an applicant, an approver, and a job-related person communicate with each other by transmitting/receiving electronic mails.

An applicant 7001, i.e., a person who needs approval by a supervisor, fills out an application form, scans the application form using the multifunction peripheral 2004, and sends a scanned image of the application form attached to an electronic mail to an approver 7005. In FIG. 7, the applicant 7001 sends an electric mail to the approver 7005 by designating an approver's mail address in the “To” field (see 7010).

In this case, the applicant 7001 can additionally designate a mail address of a job-related person 7004 and a mail address of the applicant 7001 in the “Cc” and “Bcc” fields, for the purpose of letting the job-related person know a current status of the application procedure and storing a backup copy of the contents of the application. (Bcc stands for “Blind Carbon Copy)

In FIG. 7, the multifunction peripheral 2004 sends an electronic mail designating the job-related person 7004 in the “Cc” field (see 7011). When the job-related person 7004 activates mail software operable on the job-related person's PC 2006, the job-related person's PC 2006 can receive the mail sent from the multifunction peripheral 2004. The job-related person 7004 can confirm the presence of an application sent from the applicant 7001 to the approver 7005.

In FIG. 7, the multifunction peripheral 2004 sends an electronic mail designating the applicant 7001 in the “Bcc” field (see 7012). When the applicant 7001 activates mail software operable on the applicant's PC 2002, the applicant's PC 2002 can receive the mail sent from the multifunction peripheral 2004. The applicant 7001 can store a backup copy of the application in applicant's PC 2002. When the applicant 7001 receives an electronic mail notifying an approval result from the approver 7005, the applicant 7001 can manage the approval result while associating it with the application. The mail sending procedures 7011 and 7012 are generally performed to effectively use the functions of the multifunction peripheral 2004, although they are not essentially required in the application task workflow.

The application form used in the mail sending procedures 7010, 7011, and 7012 is a paper document. The multifunction peripheral 2004 scans the application form (paper document) and sends an electronic mail with an attached image of the scanned application form. Mail sending procedures 7020, 7021, and 7022 indicate transmission of electronic mails including application contents as part of a mail body (text), instead of paper.

The applicant 7001 generates an electronic mail for an application (i.e., a mail including application contents as part of a mail body) by activating mail software operable on the applicant's PC 2002. The applicant 7001 sends the generated mail to the approver 7005 (see 7020). The applicant 7001 sends a “Cc” mail to the job-related person 7004 (see 7021). The applicant 7001 sends a “Bcc” mail to the applicant himself/herself (see 7022).

The mail software operable on the applicant's PC 2002 and the job-related person's PC 2006 is, for example “Outlook Express” provided by Microsoft Corporation or “Thunderbird” available as open source software.

The approver 7005 performs an approval work. The approver 7005 receives an electronic mail sent from the applicant (see 7010 or 7020) by using the software illustrated in FIG. 5 operable on the multifunction peripheral 2005a. The approver 7005 causes the multifunction peripheral 2005a to print an application form attached to the mail (see 7010) or a text of the mail (see 7020) as an application form.

The approver 7005 performs an approval work 7030 on a printed application form. The approval work 7030 includes writing an approval/rejection determination result, signing approver's name, and putting an approver's seal on the application form. When the approver 7005 completes the approval work 7030, the approver 7005 scans the application form and sends a reply mail including an image of the scanned application form using the software operable on the multifunction peripheral 2005a illustrated in FIG. 5.

Mail sending procedures 7040 and 7041 indicate reply mails sent from the approver 7005. The multifunction peripheral 2005a sends a reply mail (“To” mail) to an address designated in the “Reply-To” or “From” field of the mail received in the mail sending procedure 7010 or 7020 (see 7040). Furthermore, the multifunction peripheral 2005a sends a reply mail (“Cc” mail) to an address designated in the “Cc” field of the mail received in the mail sending procedure 7010 or 7020 (see 7041).

Control data “From”, “To”, “Cc”, “Bcc”, and “Reply-To” are in a header portion of an electronic mail. An address of a sending source is described in the “From” field. A sender's name, as an option, can be added to the “From” field. An address of a destination is described in the “To” field. A receiver's name, as an option, can be added to the “To” field. If a user designates mail addresses in the “Cc” and “Bcc” fields when the user sends an electronic mail designating an address in the “To” field, an electric mail having the same content is sent to the addresses designated in the “Cc” and “Bcc” fields. The mail sent to the address designated in the “Bcc” field is not notified to a receiver designated in the address in the “To” field.

A user can use the “Reply-To” field to designate an address of a reply mail. More specifically, if no address is described in the “Reply-To” field, destination of a reply mail is the address in the “From” field. If an address is described in the “Reply-To” field, destination of a reply mail is the address in the “Reply-To” field, not the address in “From” field.

In an exemplary embodiment, the approver 7005 uses the multifunction peripheral 2005a to perform reception of mails and sending of reply mails. In another exemplary embodiment (second exemplary embodiment), the approver 7005 can use two or more multifunction peripherals.

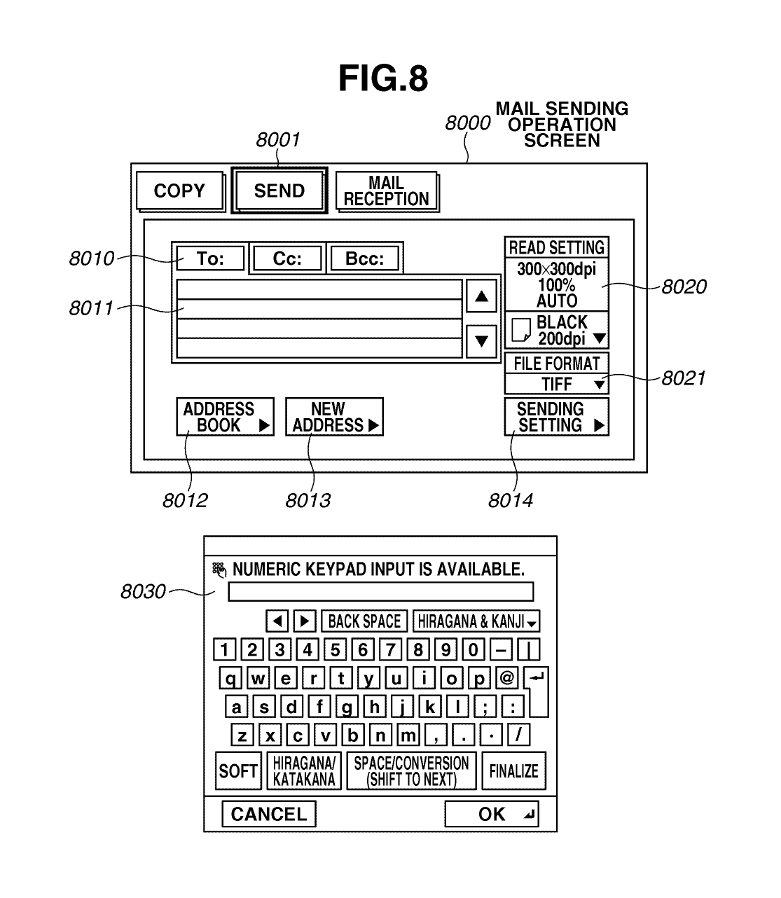

FIG. 8 illustrates an example of mail sending operation screen 8000, which can be provided by the software configuration illustrated in FIG. 7 and displayed on the LCD unit 6001 of the operation unit 3050. The sending operation screen 8000 enables a user to instruct mail sending operations (see 7010, 7011, and 7012) in the application task workflow.

A function setting button 8001 enables a user to select the function of software. FIG. 8 illustrates a “Send” function currently selected. An address type switching button 8010 enables a user to select the type of mail address among “To”, “Cc”, and “Bcc.” The screen example illustrated in FIG. 8 is in a state where a user can designate an address in the “To” field. A set address list display unit 8011 displays mail addresses in the “To”, “Cc”, and “Bcc” fields, which are selected from an address book or manually input by a user. If a user presses an address book button 8012, the address book manager 5016 illustrated in FIG. 5 acquires address data registered in the address book information storage unit 5023 and displays a list of acquired addresses. A user can set addresses selected from the list to the “To”, “Cc”, and “Bcc” fields.

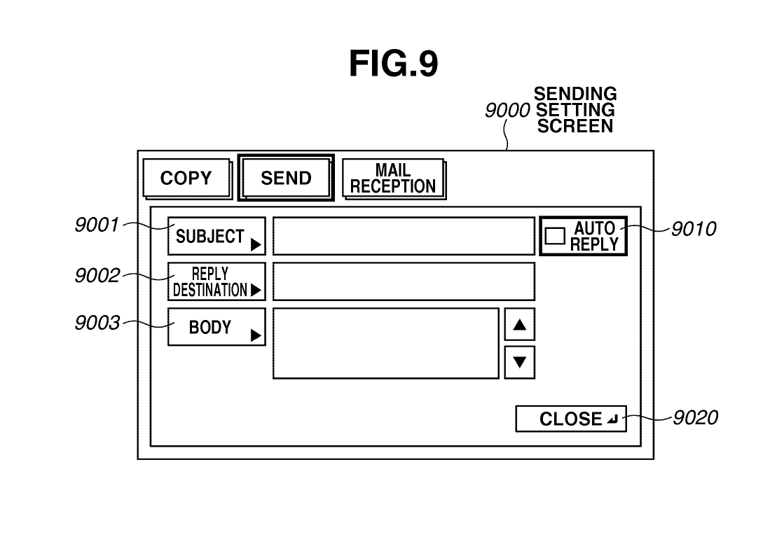

If a user presses a new address button 8013, a soft keyboard 8030 appears and enables a user to designate any mail address which is not found in the address book using the function of inputting hiragana (a type of Japanese character), katakana (a type of Japanese character), and alphanumeric letters and symbols. When a user presses a sending setting button 8014, a sending setting screen illustrated in FIG. 9 appears to enable the user to perform detailed mail settings. A read setting button 8020 enables a user to change read settings (e.g., resolution, magnification, and color designation) in a scanning operation for reading an application form performed by the scanner unit 4001 illustrated in FIG. 4. A file format button 8021 enables a user to select a file format of image data when the scanned application form is attached to an electronic mail.

FIG. 9 illustrates an example of a sending setting screen 9000 displayed when a user presses the sending setting button 8014 illustrated in FIG. 8. The sending setting screen 9000 includes a mail subject input field 9001, a reply mail address (Reply-To) input field 9002, and a mail body input field 9003. When a user presses the input field 9001, 9002, or 9003, the soft keyboard 8030 illustrated in FIG. 8 appears to enable the user to input a character string.

A user can input a subject of a mail in the subject input field 9001, i.e., one of the fields provided in the mail header.

An auto-reply button 9010 is a toggle button, which alternately switches the setting between “enabled” and “disabled” in response to a pressing operation by a user. Automatic generation of a reply mail is feasible when a user presses the auto-reply button 9010 to set the “enabled” state.

A user can press a button 9020 to close the sending setting screen 9000 and display the mail sending operation screen 8000 illustrated in FIG. 8.

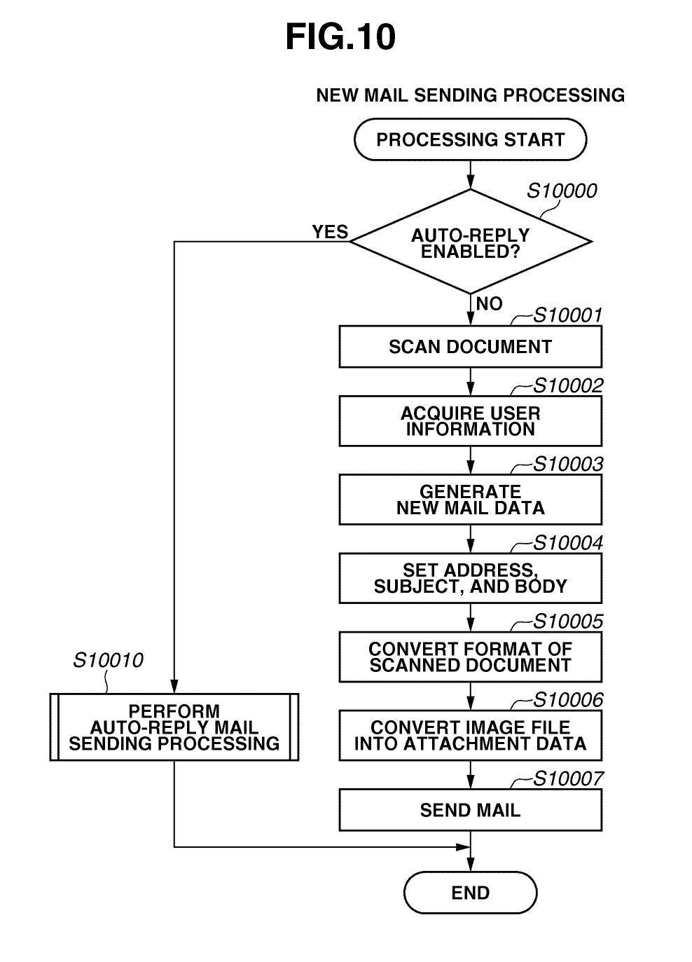

FIG. 10 is a flowchart illustrating an example of a mail sending processing (see 7010, 7011, and 7012) in the application task workflow illustrated in FIG. 7. The mail processing control unit 5003 illustrated in FIG. 5 executes the mail sending processing illustrated in FIG. 10 when the applicant 7001 presses the start key 6003 illustrated in FIG. 6 after completing the address and read settings on the screens illustrated in FIGS. 8 and 9.

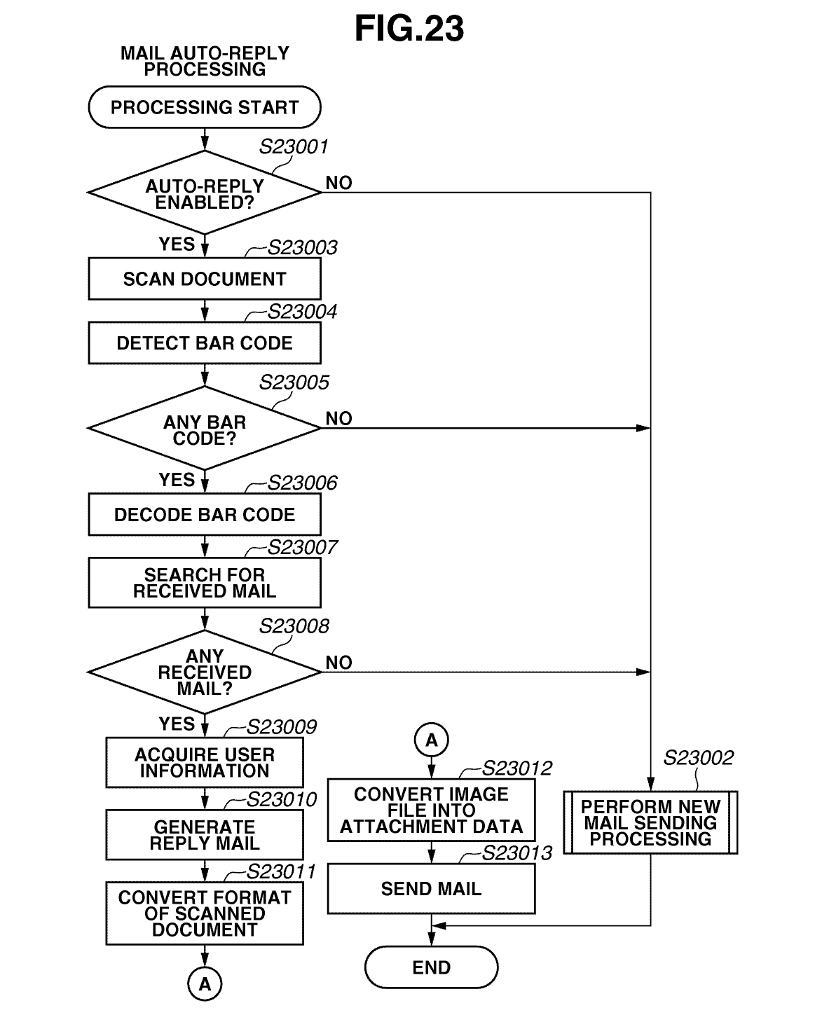

In step S10000, the mail processing control unit 5003 determines whether the auto-reply setting is enabled by the auto-reply button 9010 illustrated in FIG. 9. If the auto-reply setting is enabled (YES in step S10000), the processing proceeds to step S10010. In step S10010, the mail processing control unit 5003 executes auto-reply mail sending processing and terminates the processing of this routine. FIG. 23 illustrates details of the auto-reply mail sending processing, as described below. If the auto-reply setting is disabled (NO in step S10000), the processing proceeds to step S10001.

In step S10001, the mail processing control unit 5003 instructs the scanning manager 5012 to cause the scanner 3040 to read an application form (a paper document) placed on the scanner unit 4001. The RAM 3002 or the HDD 3004 stores read image data.

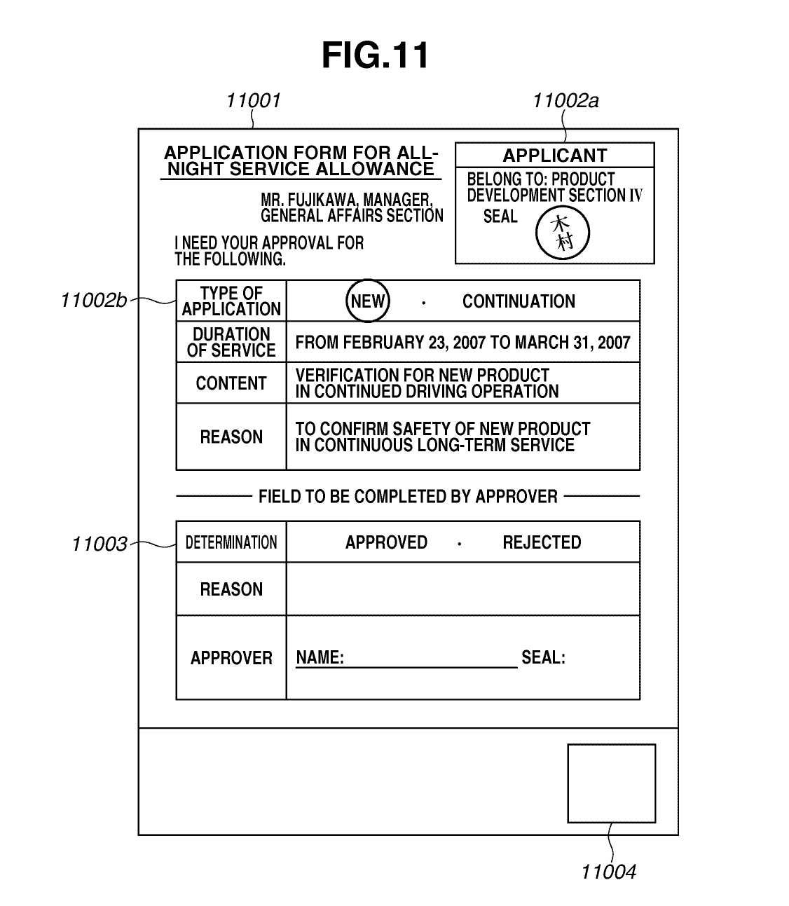

FIG. 11 is example of image data 11001 of the application form read by the scanner 3040. The image data 11001 includes fields 11002a and 11002b where the applicant 7001 can input (write) applicant's name and application contents. Furthermore, the image data 11001 includes a field 11003 where the approver 7005 can input (write) a determination result and a field 11004 where a two-dimensional bar code image can be printed in a printing operation. The fields 11003 and 11004 are blank when the applicant 7001 sends the application form.

In step S10002, the mail processing control unit 5003 instructs the user manager 5014 to acquire, from the user information storage unit 5021, mail account information (registered in a mail server) of a user (e.g., applicant 7001) currently logging-on the multifunction peripheral and store the acquired mail account information in the RAM 3002.

In step S10003, the mail processing control unit 5003 generates mail data of the mails sent by the applicant 7005 (see 7010, 7011, and 7012). More specifically, the mail processing control unit 5003 generates and sets a “Message-ID” identifying each mail and sets a “From” address representing a mail address of the user (e.g., the applicant 7001) currently using the multifunction peripheral.

The “Message-ID” is one of the fields provided in the mail header. The “Message-ID” describes an identifier to differentiate another mail from a certain mail.

For example, the “Message-ID” is unique information allocated to each mail, although its format is not limited to a specific format.

In step S10004, the mail processing control unit 5003 sets the information/data designated via the mail sending operation screen 8000 and the sending setting screen 9000 to the new mail data generated in step S10003. More specifically, the settings in the “To”, “Cc”, and “Bcc” fields entered via the mail sending operation screen 8000 and the settings in the “Subject”, “Reply-To”, and the mail body entered via the sending setting screen 9000 are set to the new mail data generated in step S10003. In the mail sending procedures 7010, 7011, and 7012, the applicant 7001 designates a mail address of the approver 7005 in the “To” field, a mail address of the job-related person 7004 in the “Cc” field, and a mail address of the applicant 7001 in the “Bcc” field.

In step S10005, the mail processing control unit 5003 converts the file format of the image data read in step 10001 into a file format designated by the file format button 8021 of the mail sending operation screen 8000. The file format is, for example, PDF or TIFF. The RAM 3002 or the HDD 3004 stores the converted file data.

In step S10006, the mail processing control unit 5003 converts the image file obtained in step S10005 into image data having a code format attachable to an electronic mail. More specifically, the mail processing control unit 5003 encodes the image file obtained in step S10005 into Base 64 data according to the regulations of Multipurpose Internet Mail Extensions (MIME).

In step S10007, the mail processing control unit 5003 performs mail sending processing. More specifically, the mail processing control unit 5003 completes generation of mail data by combining the new mail data generated in step S10004 with the attachment file data generated in step S10006. Next, the mail processing control unit 5003 accesses the mail server referring to the account information acquired in step S10002 and sends the mail data to the mail server.

In this manner, the mail processing control unit 5003 performs the mail sending procedures 7010, 7011, and 7012.

The general mail software operable on the applicant's PC 2002 can send an application form (electronic data instead of paper) contained as part of an electronic mail in the mail sending procedures 7020, 7021, and 7022 illustrated in FIG. 7. The mail sending processing is variable depending on the mail software installed on the applicant's PC 2002 and is not directly related to the present invention, and is therefore not described below in detail.

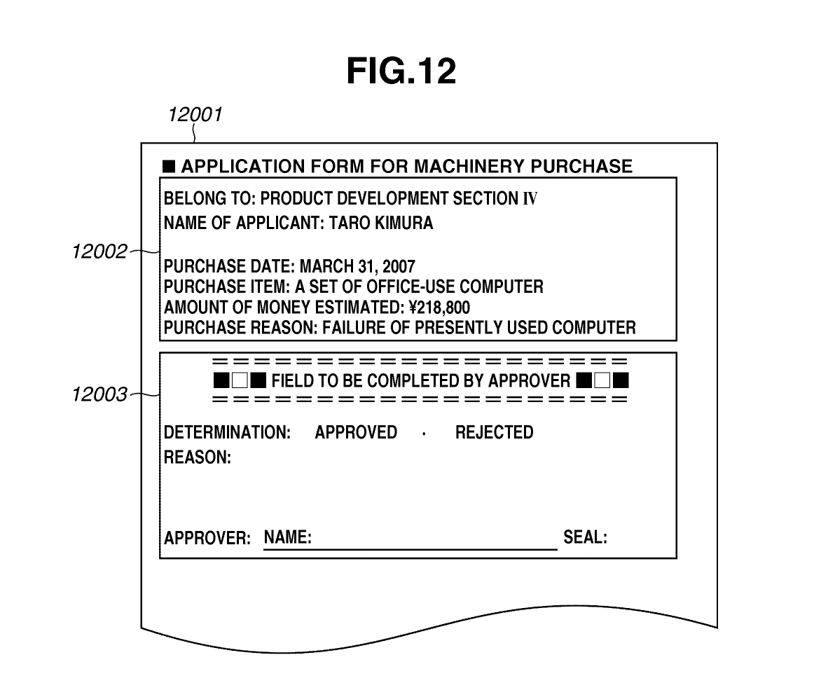

FIG. 12 illustrates an example mail body (text) 12001 of an electronic mail containing an application form, sent in the mail sending procedures 7020, 7021, and 7022. The mail body 12001 includes a field 12002 to be completed by the applicant 7001 and a field 12003 to be completed by the approver 7005. The field 12002 includes a description relating to applicant's name and application contents. The field 12003 includes a description relating to approval/rejection determination and approver's signature/seal, although it is currently blank.

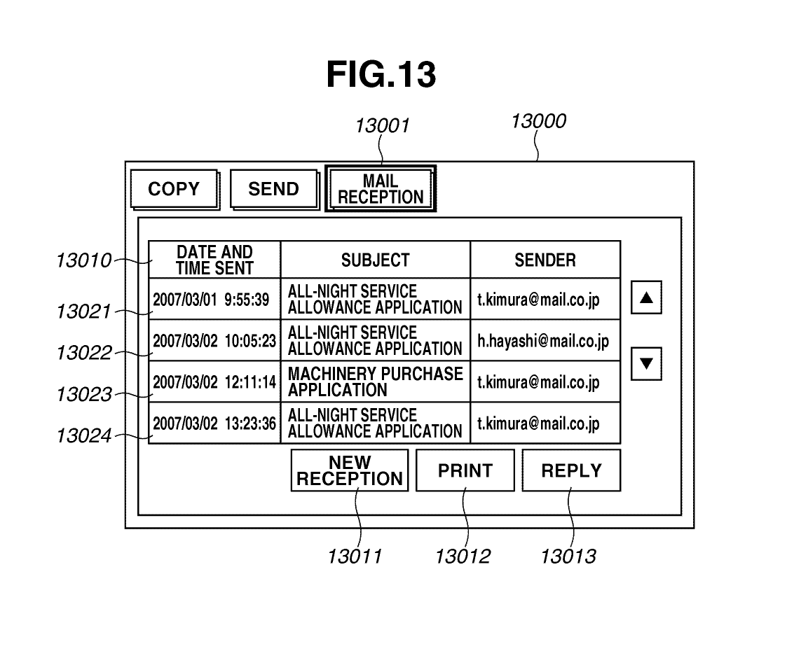

FIG. 13 illustrates an example of a mail reception operation screen 13000, which can be provided by the software configuration illustrated in FIG. 5 and displayed on the LCD unit 6001 of the operation unit 3050. The reception operation screen 13000 enables the approver 7005 to instruct the multifunction peripheral 2005a to receive a mail sent in the application task workflow illustrated in FIG. 7.

A function switching button 13001 enables a user to select the function of software. FIG. 13 illustrates a “Mail Reception” function currently selected. A reception mail list display area 13010 displays a list of received mails. The reception mail list includes main information, such as date and time sent, subject, and sender (From Address), of each reception mail. A user can select an arbitrary reception mail by pressing a corresponding line in the area 13010.

Although the example list display area 13010 in FIG. 13 displays only three items (i.e., date and time sent, subject, and sender), any other mail information of the sender (e.g., information selected from the mail header fields or part of the mail body) can be displayed.

The approver 7005 can press a new reception button 13011 to cause the multifunction peripheral 2005a to execute mail reception processing. When the approver 7005 presses a mail print button 13012, the multifunction peripheral 2005a executes print processing for a mail selected in the reception mail list display area 13010. When the approver 7005 presses a reply mail generation button 13013, the multifunction peripheral 2005a generates a reply mail responding to a mail selected in the reception mail list display area 13010 and sends the generated reply mail.

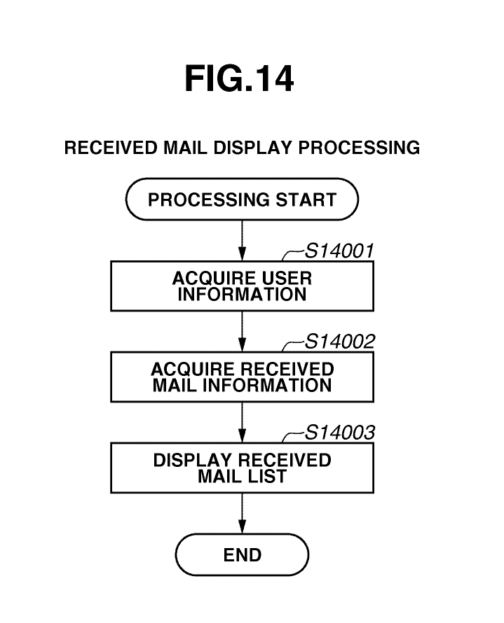

FIG. 14 is a flowchart illustrating example of a received mail display processing, executed by the mail processing control unit 5003 illustrated in FIG. 5 when the function switching button 13001 is pressed to display the mail reception operation screen 13000.

In step S14001, the mail processing control unit 5003 instructs the user manager 5014 to acquire, from the user information storage unit 5021, mail account information (registered in a mail server) of a user (e.g., applicant 7001) currently logging-on the multifunction peripheral and store the acquired mail account information in the RAM 3002.

In step S14002, the mail processing control unit 5003 instructs the mail data manager 5010 to acquire a header information list of the mails received by the user currently logging-on the multifunction peripheral. The mail data manager 5010 acquires a header information list of the mails received by the approver 7005 from the mail information storage unit 5020.

In step S14003, the mail processing control unit 5003 displays a list of received mails in the reception mail list display area 13010 based on the mail header information list acquired in step S14002.

As described above, the mail reception operation screen 13000 containing the list of received mails can be displayed by executing the processing illustrated in FIG. 14.

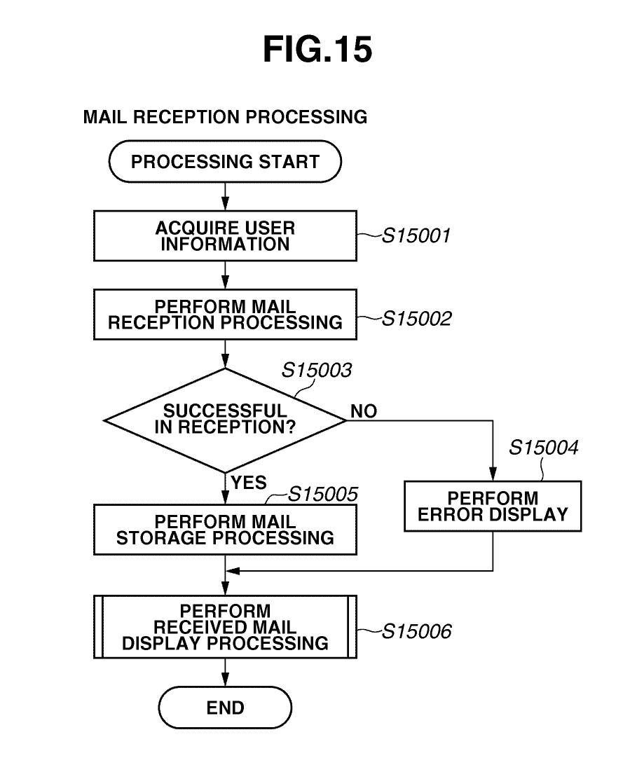

FIG. 15 is a flowchart illustrating an example of a mail reception processing according to an exemplary embodiment, performed by a multifunction peripheral to receive a mail when a user presses the new reception button 13011 in the mail reception operation screen 13000. The mail processing control unit 5003 illustrated in FIG. 5 executes the mail reception processing illustrated in FIG. 15.

More specifically, in the application task workflow illustrated in FIG. 7, the multifunction peripheral 2005a executes the mail reception processing illustrated in FIG. 15 when the approver 7005 receives a mail from the applicant 7001.

In step S15001, the mail processing control unit 5003 instructs the user manager 5014 to acquire, from the user information storage unit 5021, mail account information (registered in a mail server) of the approver 7005 currently logging-on the multifunction peripheral and store the acquired mail account information in the RAM 3002.

In step S15002, the mail processing control unit 5003 accesses a reception mail server based on the mail account information acquired in step S15001 and receives an unreceived mail addressed to the approver 7005.

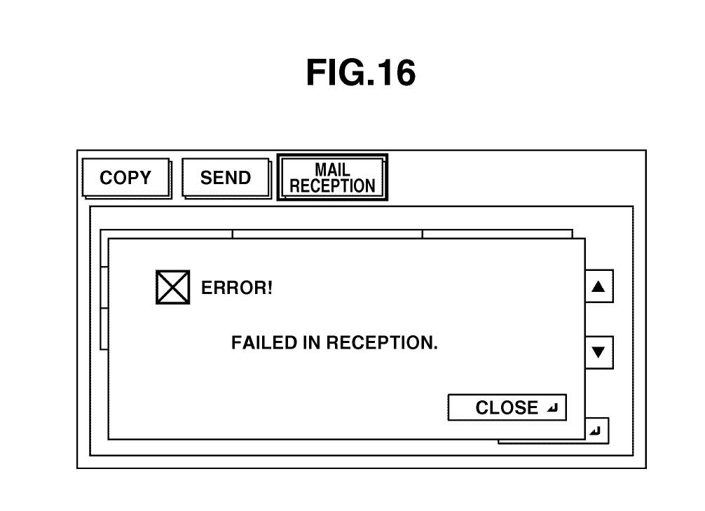

In step S15003, the mail processing control unit 5003 determines whether the mail reception processing (performed in step S15002) was successful. If the mail reception processing has failed, e.g., when the mail server is inaccessible (NO in step S15003), the processing proceeds to step 15004. In step S15004, the mail processing control unit 5003 causes the multifunction peripheral 2005a to notify the approver 7005 of failure in mail reception. FIG. 16 illustrates an example of a notification screen.

If the mail processing control unit 5003 completes the error notification processing, the processing proceeds to step S15006. In step S15006, the mail processing control unit 5003 executes the received mail display processing illustrated in FIG. 14 again and updates the display of the screen.

If the mail reception processing is successful (YES in step S15003), the processing proceeds to step S15005. In step S15005, the mail processing control unit 5003 instructs the mail data manager 5010 to store a received mail in the mail information storage unit 5020.

After completing storing the received mail in the mail information storage unit 5020, the processing proceeds to step S15006. In step S15006, the mail processing control unit 5003 executes the received mail display processing illustrated in FIG. 14 again. Thus, the mail newly received in step S15002 can be displayed in the reception mail list display area 13010.

In FIG. 13, the reception mail list display area 13010 includes mails 13021, 13022, 13023, and 13024 received by the approver 7005 through the mail reception processing illustrated in FIG. 15 and displayed through the received mail display processing illustrated in FIG. 14.

The mail 13021 relates to an “all-night service allowance application (see FIG. 11)” sent by an applicant having a mail address of t.kimura@mail.co.jp in the mail sending procedure 7010 illustrated in FIG. 7.

The mail 13022 relates to another “all-night service allowance application (see FIG. 11)” sent from an applicant having a mail address of h.hayashi@mail.co.jp in the mail sending procedure 7010 illustrated in FIG. 7.

The mail 13023 relates to a “machinery purchase application (see FIG. 12)” sent from the applicant having the mail address of t.kimura@mail.co.jp in the mail sending procedure 7020 illustrated in FIG. 7.

The mail 13024 relates to yet another “all-night service allowance application” sent from the applicant having the mail address of t.kimura@mail.co.jp in the mail sending procedure 7010 illustrated in FIG. 7. Although two mails 13021 and 13024 are identical in type and generated by the same applicant, the approver 7005 processes these mails 13021 and 13024 independently.

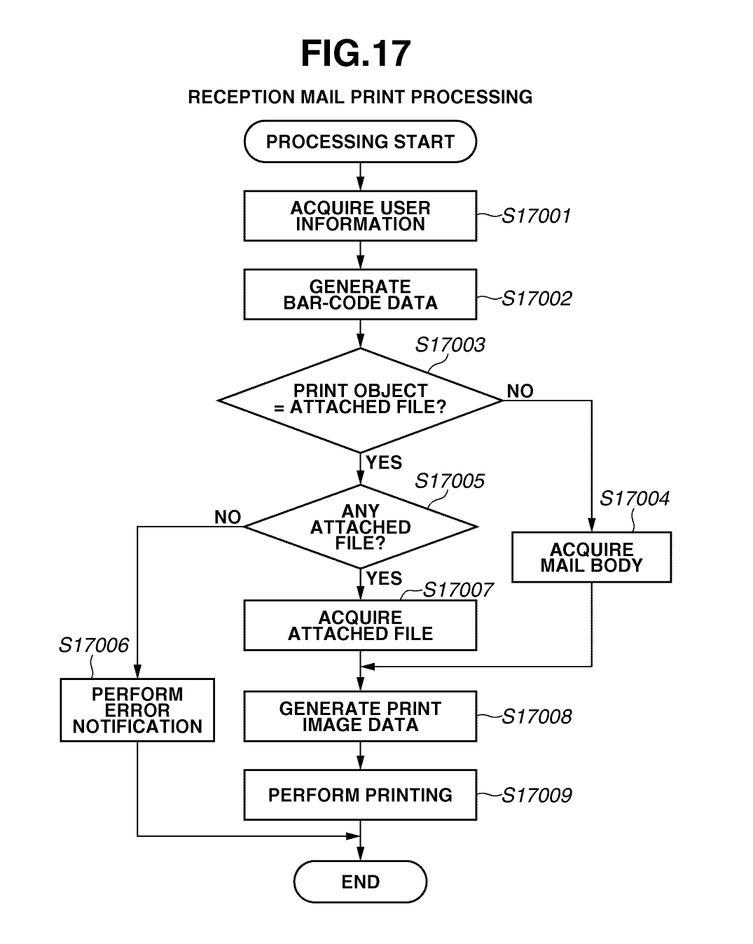

FIG. 17 is a flowchart illustrating an example of a reception mail print processing according to an exemplary embodiment, performed by a multifunction peripheral to print a received mail. The multifunction peripheral starts the reception mail print processing in response to depression of the mail print button 13012, for example when a user selects a reception mail to be printed among the reception mails displayed in the reception mail list display area 13010 of the mail reception operation screen 13000 illustrated in FIG. 13.

More specifically, in the application task workflow illustrated in FIG. 7, the multifunction peripheral 2005a used by the approver 7005 performs the reception mail print processing when the approver 7005 prints a mail received from the applicant 7001.

The mail processing control unit 5003 illustrated in FIG. 5 executes the reception mail print processing illustrated in FIG. 17.

In step S17001, the mail processing control unit 5003 acquires a selected mail in the reception mail list display area 13010 from the UI control unit 5001. Next, the mail processing control unit 5003 instructs the mail data manager 5010 to acquire information relating to the selected mail from the mail information storage unit 5021. The acquired information includes a header portion and a body portion of the received mail and a file or files if attached to the mail. The HDD 3004 temporarily stores the acquired information.

In step S17002, the mail processing control unit 5003 generates image data of a two-dimensional bar code based on the “Message-ID” described in the header of the mail information acquired in step S17001. More specifically, the mail processing control unit 5003 instructs the bar code manager 5011 illustrated in FIG. 5 to convert a character string of the Message-ID into image data of a two-dimensional bar code. The HDD 3004 temporarily stores the two-dimensional bar code image data. The two-dimensional bar code is capable of containing information in both the horizontal direction and the vertical direction. Compared to a bar code, the two-dimensional bar code can contain a larger amount of information in a smaller print area.

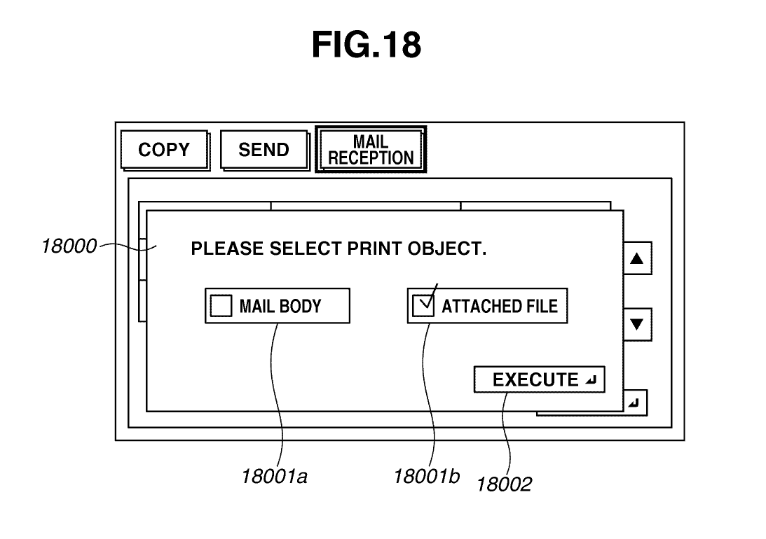

In step S17003, the mail processing control unit 5003 displays a print object selection screen illustrated in FIG. 18, which enables a user to identify mail information to be printed.

FIG. 18 illustrates an example of a print object selection screen 18000, which includes two buttons 18001a and 18001b. If one of the buttons 18001a and 18001b is enabled, the other button is disabled automatically. If a user wants to print the body of a received mail, the user enables the mail body button 18001a. If a user wants to print an attached file of a received mail, the user enables the attached file button 18001b. A user can give an instruction for executing the processing by pressing the execution button 18002.

In the application task workflow in FIG. 7, a mail containing an application form as image data attached is sent in the mail sending procedure 7010. Therefore, a user enables the attached file button 18001b. On the other hand, a mail containing an application form as part of the mail body is sent in the mail sending procedure 7020. In this case, a user enables the mail body button 18001a. If no file is attached to a mail, print object selection screen 18000 displays the mail body button 18001a in an enabled state.

Alternatively, it is possible to enable the mail body button 18001a when no file is attached to a mail, without displaying the screen illustrated in FIG. 18 (without requiring depression of the execution button 18002).

When a user presses the execution button 18002 illustrated in FIG. 18, the mail processing control unit 5003 restarts the processing of step S17003 to determine whether the print object is a mail body or an attached file. If the print object is the mail body (NO in step S17003), the processing proceeds to step S17004. If the print object is the attached file (YES in step S17003), the processing proceeds to step S17005.

In step S17004, the mail processing control unit 5003 extracts mail body data from the mail information temporarily stored in the HDD 3004 in step S17001.

In step S17005, the mail processing control unit 5003 determines whether the mail information temporarily stored in the HDD 3004 in step S17001 includes any file attached to a mail. If the mail information temporarily stored in the HDD 3004 includes no attached file (NO in step S17005), the processing proceeds to step S17006. In step S17006, the mail processing control unit 5003 performs error notification processing and cancels the print processing. If the mail information temporarily stored in the HDD 3004 includes an attached file (YES in step S17005), the processing proceeds to step S17007. In step S17007, the mail processing control unit 5003 extracts the attached file data from the mail information temporarily stored in the HDD 3004.

In step S17008, the mail processing control unit 5003 instructs the print image generation manager 5017 illustrated in FIG. 5 to combine a print image of the attached file or the mail body with the two-dimensional bar code image data stored in the HDD 3004 in step S17002. The mail processing control unit 5003 places the two-dimensional bar code image data at a predetermined position in a print area.

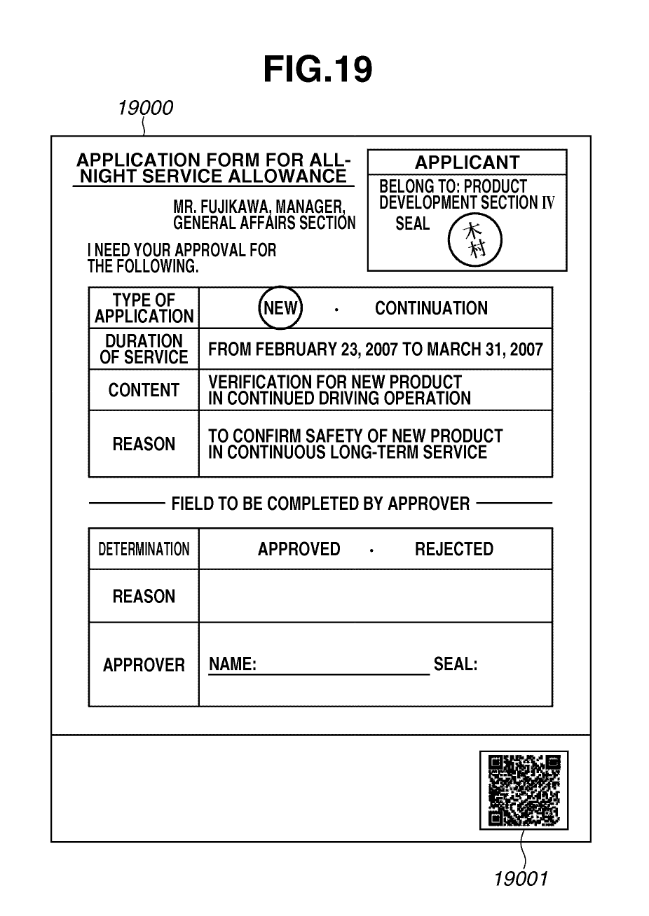

FIG. 19 illustrates an example of print image 19000 including image data of an application form attached to the mail (mail sending procedure 7010) and two-dimensional bar code image data 19001. The print image 19000 is based on image data of the application form illustrated in FIG. 11, which was read (scanned) by the multifunction peripheral and attached to the mail sent in the mail sending procedures 7010, 7011, and 7012. As illustrated in FIG. 19, the two-dimensional bar code image 19001 is combined with the image data of the application form illustrated in FIG. 11 sent from the applicant 7001.

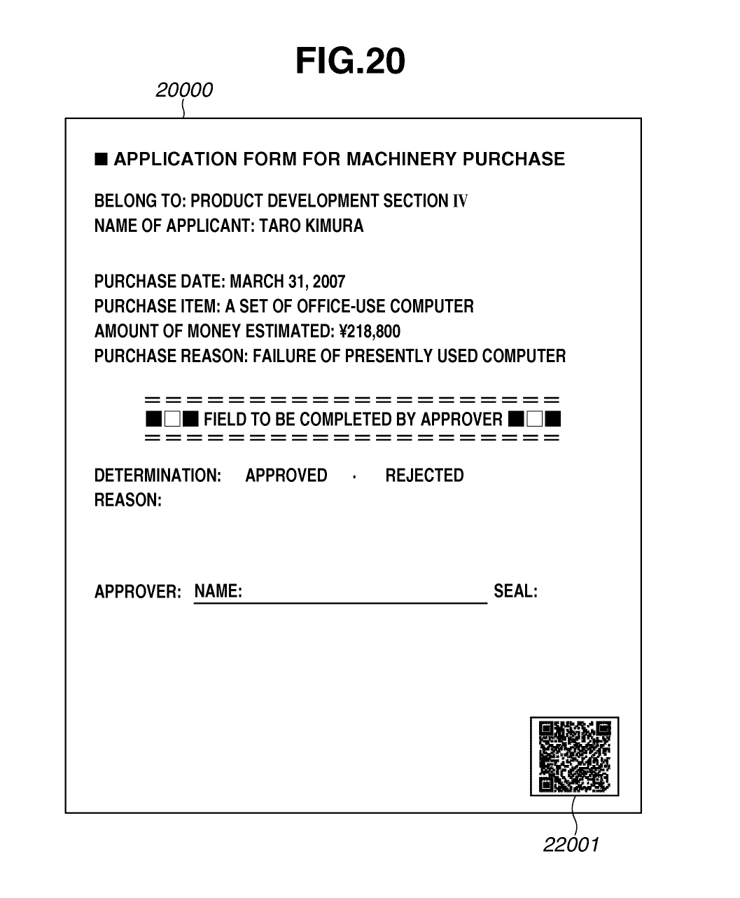

FIG. 20 illustrates an example of print image 20000 including the body of the mail sent in the mail sending procedure 7020 illustrated FIG. 7 combined with two-dimensional bar code image data. The print image 20000 is based on print data converted from the mail body 12001 (application contents) illustrated in FIG. 12. The print image 20000 includes a two-dimensional bar code 22001 generated based on the Message-ID in the mail header information.

The two-dimensional bar codes 19001 and 22001 are generally referred to as QR codes, although any other two-dimensional bar codes can be used.

In step S17009, the mail processing control unit 5003 instructs the mail print manager 5013 to cause the printer 3041 to print the print image generated in step S17008.

As described above, it is apparent that in the application task workflow illustrated in FIG. 7 the approver 7001 can obtain a paper document, i.e., a printed document including an image of the attached file or the body of a mail sent from the applicant 7001 through the reception mail print processing illustrated in FIG. 17. It is also apparent that the Message-ID contained in the received mail header information can be printed as a two-dimensional bar code on the printed document. Furthermore, it is apparent that the two-dimensional bar code does not include any other information than the Message-ID. Therefore, in a printing of a mail, the amount of printed information is not dependent on the mail header information.

The approver 7005 performs an approval work 7030 on the printed document. The approval work 7030 includes adding information, signing approver's name, and affixing an approver's seal.

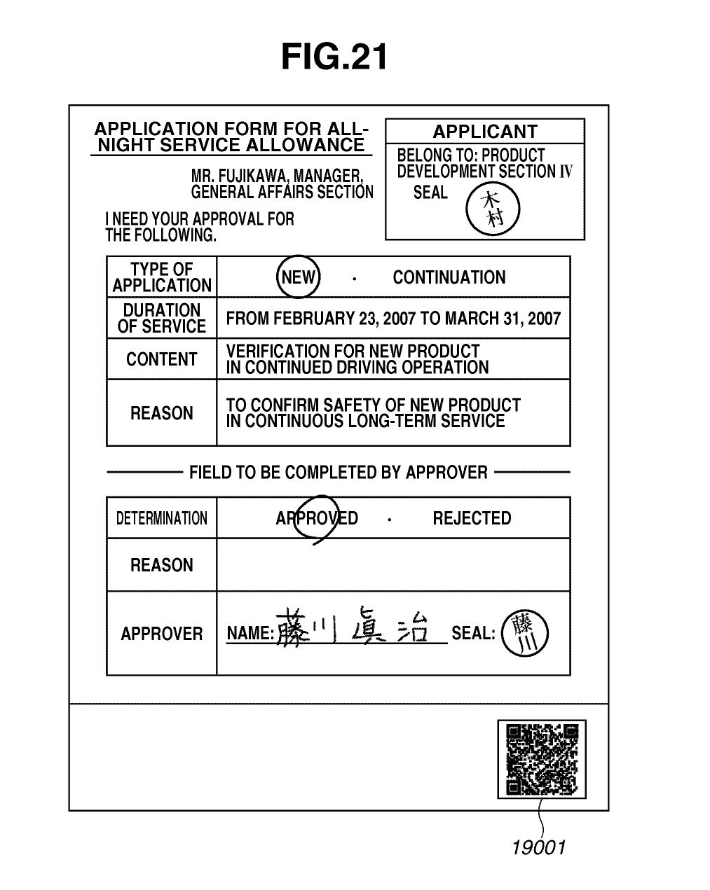

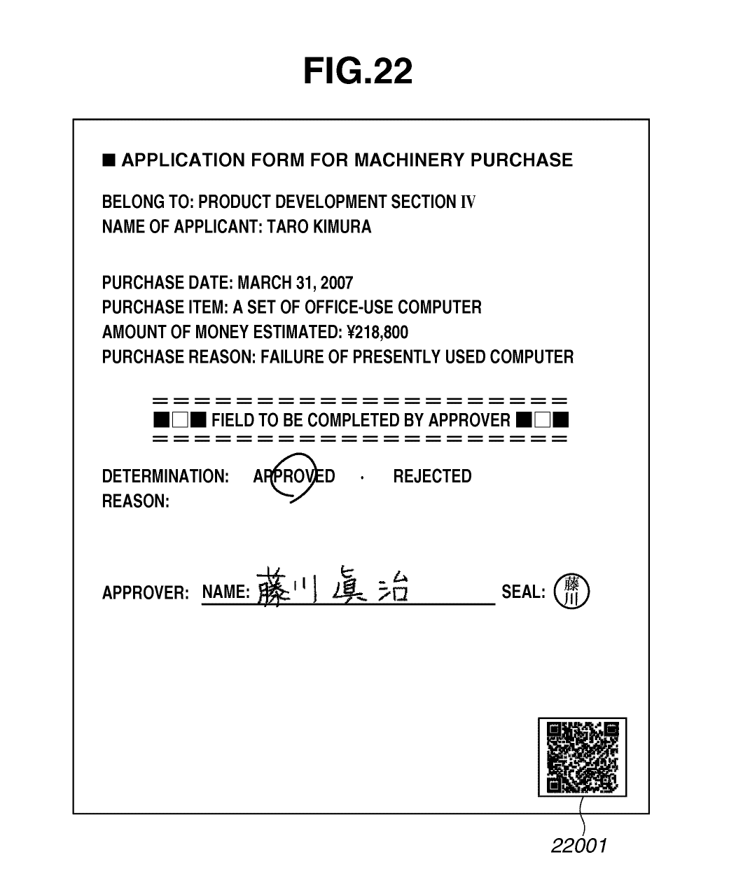

FIGS. 21 and 22 illustrate example results of the approval work performed by the approver 7005 on the printed document generated in the reception mail print processing illustrated in FIG. 17. FIG. 21 illustrates an example of an application form completed by the approver 7005 in a case where image data of the application form attached to an electronic mail is sent from the applicant 7001 in the mail sending procedure 7010. FIG. 22 illustrates an exemplary application form completed by the approver 7005 in a case where an electronic mail contains the application form as part of the body of the mail sent from the applicant 7001 in the mail sending procedure 7020. FIGS. 21 and 22 illustrate that the approver 7005 has signed his name and put his seal.

FIG. 23 is a flowchart illustrating an example of a mail auto-reply processing according to an exemplary embodiment, in which a multifunction peripheral generates a reply mail based on image data of a scanned document.

The processing illustrated in FIG. 23 starts in response to depression of the start key 6003 when the mail sending operation screen 8000 is displayed in a state where auto-reply setting of the auto-reply button 9010 is enabled on the screen illustrated in FIG. 9. The mail processing control unit 5003 illustrated in FIG. 5 executes the processing of FIG. 23.

More specifically, in the application task workflow illustrated in FIG. 7, the multifunction peripheral 2005a used by the approver 7005 performs the processing of FIG. 23 when the approver 7005 operates the multifunction peripheral 2005a to scan the application form completed by the approver 7005 and sends a mail including the scanned application form to the applicant 7001 or the job-related person 7004 in the mail sending procedures 7040 and 7041.

The mail auto-reply processing illustrated in FIG. 23 enables the multifunction peripheral 2005a to send reply mails (child mails) responding to the mails (see 7010 and 7020) received by the approver 7005 in the mail sending procedures 7040 and 7041 illustrated in FIG. 7.

The mail auto-reply processing prevents the approver 7005 from erroneously selecting a mail corresponding to the scanned application form among numerous mails sent in the mail sending procedures 7010 and 7020.

In step S23001, the mail processing control unit 5003 determines whether the auto-reply setting is enabled referring to the auto-reply setting set by the auto-reply button 9010 illustrated in FIG. 9. If the auto-reply setting is disabled (NO in step S23001), the processing proceeds to step S23002. In step S23002, the mail processing control unit 5003 executes new mail sending processing. The new mail sending processing is similar to the mail sending processing described with reference to FIG. 10.

In step S23003, the mail processing control unit 5003 instructs the scanning manager 5012 to cause the scanner 3040 to read a paper document (application form completed by the approver 7005) placed on the scanner unit 4001. The RAM 3002 or the HDD 3004 stores the read image data.

The read image is similar to those illustrated in FIGS. 21 and 22.

In step S23004, the mail processing control unit 5003 instructs the bar code manager 5011 to check the presence of any two-dimensional bar code printed at a predetermined portion in the image data read in step S23003. In step S23005, the mail processing control unit 5003 determines whether a two-dimensional bar code is printed on the scanned document. If no two-dimensional bar code is detected (NO in step S23005), the processing proceeds to step S23002.

More specifically, the scanned document is not a document printed in the reception mail print processing illustrated in FIG. 17. Therefore, to simply send an electronic mail with a scanned image file attached thereto, the mail processing control unit 5003 executes the new mail sending processing in step S23002. If a two-dimensional bar code is detected (YES in step S23005), the processing proceeds to step S23006.

In step S23006, the mail processing control unit 5003 decodes the two-dimensional bar code detected in step S23004 to obtain the original information. As described above, the two-dimensional bar code is generated in steps S17001 and S17002 illustrated in FIG. 17 based on the Message-ID of the mail sent from the applicant 7001 in the mail sending procedures 7010 and 7020 illustrated in FIG. 7. Therefore, the decoding processing in step S23006 can reconstruct the Message-ID of a mail containing the application form, which was sent from the applicant 7001 (see 7010 and 7020 in FIG. 7).

In step S23007, the mail processing control unit 5003 instructs the mail data manager 5010 to search the mail information storage unit 5020. In this case, the mail data manager 5010 searches for a mail corresponding to the Message-ID acquired in step S23006 from the mail information storage unit 5020.

The retrieval result includes the mail sent from the applicant 7001 in the mail sending procedure 7010 or 7020 illustrated in FIG. 7, because it contains the Message-ID.

In step S23008, the mail processing control unit 5003 determines whether a mail corresponding to the Message-ID is present. If there is no mail corresponding to the Message-ID (NO in step S23008), the processing proceeds to step S23002. More specifically, if the mail processing control unit 5003 determines that there is no corresponding reception mail, the multifunction peripheral cannot generate a reply mail. Therefore, the mail processing control unit 5003 performs a new mail sending operation. If there is any mail corresponding to the Message-ID (YES in step S23008), the processing proceeds to step S23009.

In step S23009, the mail processing control unit 5003 instructs the user manager 5014 illustrated in FIG. 5 to acquire, from the user information storage unit 5021, mail account information (registered in a mail server) of the applicant 7001 currently logging-on the multifunction peripheral and store the acquired mail account information in the RAM 3002.

In step S23010, the mail processing control unit 5003 performs reply mail generation processing. When the approver 7005 receives a mail from the applicant 7001 (see 7010 and 7020 in FIG. 7), the approver 7005 returns a reply mail to the applicant 7001. More specifically, the reply mail is a child mail responding to a mail sent from the applicant 7001, which can be generated according to the regulations of RFC2822.

Information relating to the mail sent from the applicant 7001, which can be referred to as “parent mail information”, is already acquired in step S23007.

The reply mail generation processing in step S23010 includes the following contents f) to l).

f) The mail processing control unit 5003 generates a new Message-ID for a reply mail and sets the generated “Message-ID” as header information of the reply mail.
g) The mail processing control unit 5003 sets the Message-ID (header information) of the parent mail information to the “In-Reply-To” (header information) field of the reply mail.
h) The mail processing control unit 5003 adds the “Message-ID” (header information) of the parent mail information to the tail of the “References” (header information) of the parent mail information, and sets the added information to the “References” (header information) field of the reply mail.
i) The mail processing control unit 5003 sets an address in “Reply-To” of the parent mail information or an address in “From”, if not designated in “Reply-To”, to the “To” field of the reply mail.
j) The mail processing control unit 5003 sets the address designated in “Cc” of the parent mail information to the “Cc” field of the reply mail.
k) The mail processing control unit 5003 puts “Re:” to the head of “Subject” of the parent mail information and sets it to the “Subject” field of the reply mail.
l) The mail processing control unit 5003 sets the mail body of the parent mail information to the body of the reply mail.

Through the above-described processing f) to h), the reply mail can be defined as a child mail of the mail sent from the applicant 7001 (see 7010 and 7020 in FIG. 7).

According to the conventional technique, it is required to print parent mail information (e.g., Message-ID and References) for the above-described processing beforehand and perform OCR processing for reading the printed information. If the “References” field contains Message-IDs of numerous mails, the information amount of the “References” field increases and accordingly a required print area increases.

However, according to an exemplary embodiment, the information contained in a printed two-dimensional bar code is limited to only the “Message-ID” of the parent mail information. The “References” is not printed. Accordingly, the print area does not vary depending on the information amount of the “References” field. In the above-described processing i) to l), the mail processing control unit 5003 sets the address and the “Subject” of the reply mail referring to the information of the original mail designated in the mail sending procedures 7010 and 7020 in FIG. 7. In particular, the processing i) and j) relating to the address of the reply mail is important.

The conventional technique also requires printing the required information beforehand and performing OCR processing to read the printed information. If the information amount in the “Cc” field increases, a required print area increases correspondingly. However, according to an exemplary embodiment, the required information is not printed and acquired from the original mail stored in the multifunction peripheral. Therefore, a print area for the required information is unnecessary.

The “In-Reply-To” field, which is one of mail header fields, can be used in a reply mail to cite the “Message-ID” of the original mail.

The “References” field, which is one of the mail header fields, can be used in a reply mail to cite both the “References” and the “Message-ID” of the original mail. If the original mail does not include the “References” field, all of the information in the “In-Reply-To” and the “Message-ID” of the original mail can be cited.

Accordingly, by referring to the information described in the “References” or “In-Reply-To” field, it is possible to identify the destination of the reply mail. In this respect, the “References” or “In-Reply-To” field can be effectively used to accurately identify the destination of each reply mail when the approver communicates with numerous applicants.

The mail software can utilize the “Message-ID” and the “References” to perform a thread display (display of a parent-child relationship).

In step S23011, the mail processing control unit 5003 converts the image data read in step S23003 into a file format designated by the file format button 8021 of the mail sending operation screen 8000. The RAM 3002 or the HDD 3004 stores the converted file data.

In step S23012, the mail processing control unit 5003 converts the image file obtained in step S23011 into image data having a code format attachable to an electronic mail. More specifically, the mail processing control unit 5003 encodes the image file obtained in step S23011 into Base 64 data according to the regulations of MIME.

In step S23013, the mail processing control unit 5003 performs mail sending processing. More specifically, the mail processing control unit 5003 completes generation of reply mail data by combining the reply mail data generated in step S23010 with the attachment file data generated in step S23012. Next, the mail processing control unit 5003 accesses the mail server referring to the account information acquired in step S23009 and sends the mail data to the mail server.

Thus, it is understood that the exemplary embodiment can solve the above-described problem in the conventional technique relating to an increase in the amount of output mail header information and an increase in the required print area.

When the approver 7005 prints the body of an application mail or an attached file in the application task workflow, only the Message-ID is embedded into a two-dimensional bar code. It is apparent that the information amount does not vary depending on the number of addresses designated in the “To” or “Cc” field or the content of a mail itself. Although not specifically determined, the length of a Message-ID is approximately 100 bytes or less, which is the amount of information sufficiently small to be printed as a two-dimensional bar code on a paper.

Furthermore, the exemplary embodiment can solve the problem relating to a mail generation processing for enabling the approver 7005 to return a mail as a child mail responding to the applicant's mail (parent mail). The multifunction peripheral used by the approver 7005 can read a Message-ID from a scanned document and identifies an applicant's mail stored in the multifunction peripheral based on the read Message-ID. Accordingly, the approver 7005 needs not to carefully select a parent mail, so that any error in selection can be avoided. Furthermore, it is possible to set the contents of the “To”, “Cc”, and “Subject” fields and the body of a mail based on the information of a specified mail.

As described above, an exemplary embodiment employs a method for printing a two-dimensional bar code containing a Message-ID and reading the embedded Message-ID. This method is effective compared to a conventional method because a two-dimensional bar code can contain a greater amount of coded information and can reduce a required print area. However, it is apparent that no problem arises even when a method for printing a Message-ID as an ordinary character string and performing the OCR processing to read the Message-ID is employed as before. In short, a two-dimensional bar code is an example which can serve as electronic mail identification information (i.e., information used to identify mail information). On the other hand, when the Message-ID is directly printed on a paper, a character string serves as electronic mail identification information.

As another coding and reading method not using a two-dimensional bar code, radio frequency identification (RFID) technique can be used to embed a Message-ID in a paper supporting RFID.

Compared to the first exemplary embodiment, a second exemplary embodiment allows the approver 7005 to use a plurality of multifunction peripherals.

According to the second exemplary embodiment, the approver 7005 may use one multifunction peripheral to receive an applicant's mail and print an application form and another multifunction peripheral to return an application form processed by the approver 7005 to the applicant 7001.

A business workflow system according to the second exemplary embodiment is similar to the business workflow system described in the first exemplary embodiment and is therefore not described below.

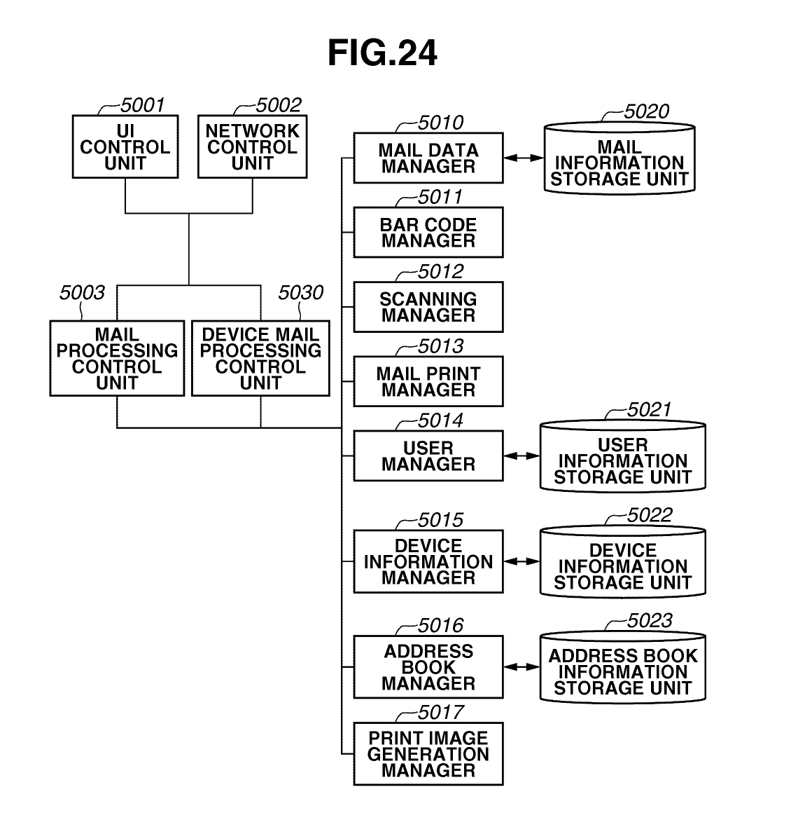

FIG. 24 illustrates an exemplary software configuration of a multifunction peripheral and a data storage unit according to the second exemplary embodiment, which is different in the following features from the configuration illustrated in FIG. 5.

A device mail processing control unit 5030, which can be loaded from the HDD 3004 in a system startup operation of the multifunction peripheral, at all times performs monitoring mails transferred between devices, via the network control unit 5002, and performs mail automatic sending processing in response to reception of a transferred mail. The device mail processing control unit 5030 instructs the mail data manager 5010, the bar code manager 5011, user manager 5014, and the device information manager 5015 to perform acquisition and storage of necessary data.

The second exemplary embodiment is different from the first exemplary embodiment only in the reception mail print processing (i.e., processing for printing a mail sent from the applicant 7001) and the mail auto-reply processing (i.e., processing for returning an application form completed by the approver 7005).

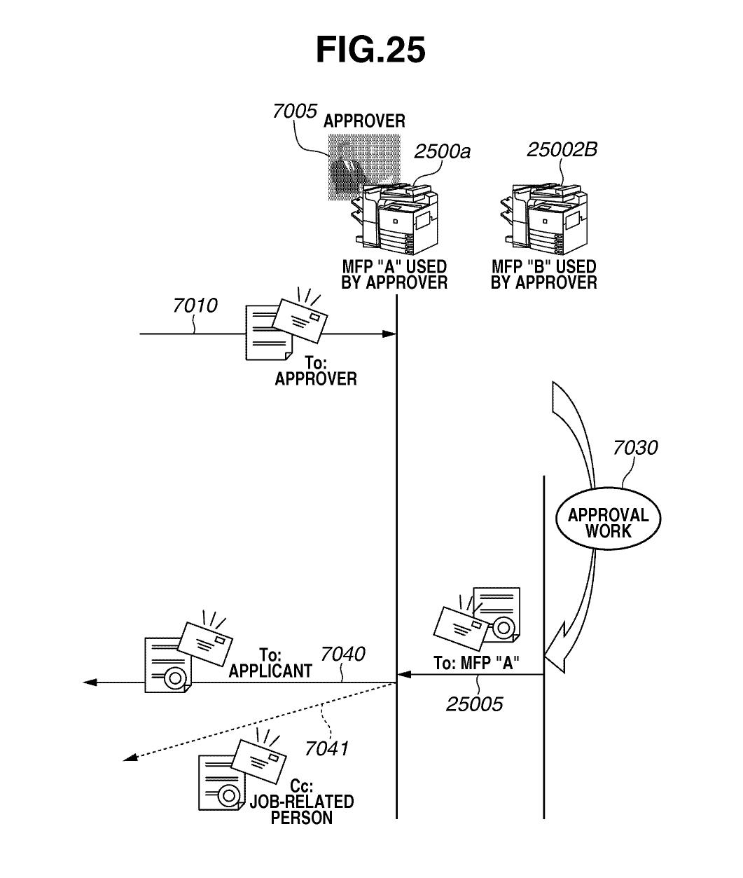

FIG. 25 illustrates an example of mail reception and reply operations performed by the approver 7005 according to the second exemplary embodiment, in the application task workflow based on mail sending operations illustrated in FIG. 7.

The approver 7005 can operate two multifunction peripherals 2500a and 2500b. According to the illustration of FIG. 25, the multifunction peripheral 2500a receives a mail from the applicant 7001 and prints the received mail. The multifunction peripheral 2500b returns a reply mail containing an application form completed by the approver 7005 to the applicant 7001. On the contrary, the approver 7005 can operate the multifunction peripheral 2500b to receive/print a mail and the multifunction peripheral 2500a to send a reply mail.

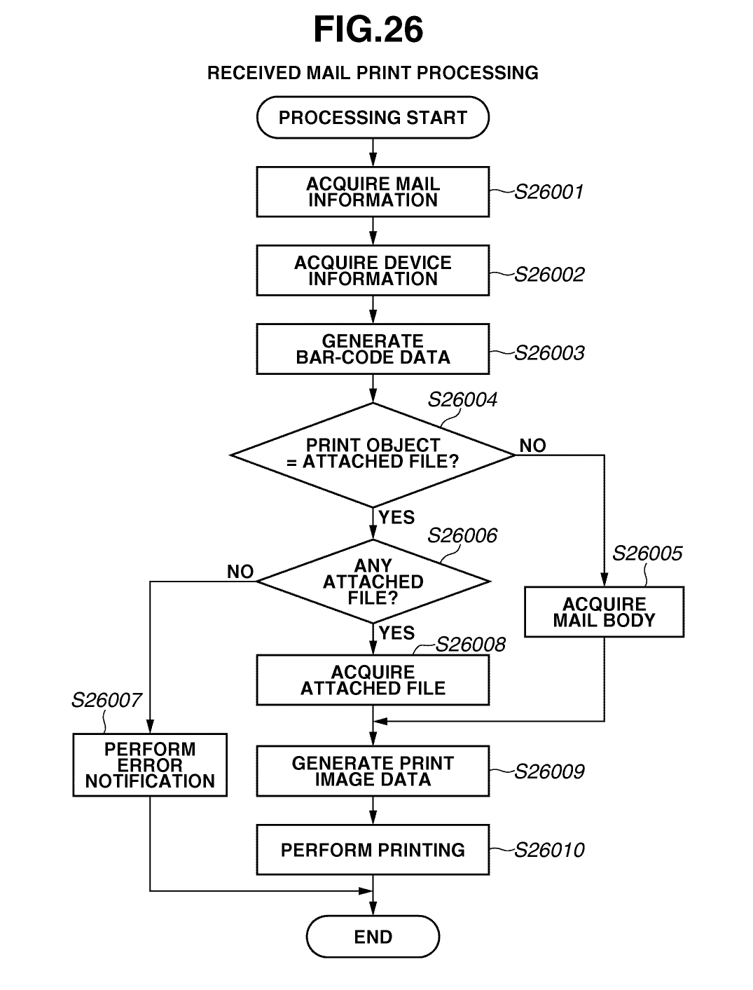

In the mail sending procedure 7010, an electric mail containing an application form is sent from the applicant 7001 to the approver 7005 similar to the procedure in FIG. 7. The approver 7005 operates the multifunction peripheral 2500a to receive the mail from the applicant 7001 and print a file attached to the mail or the body of the mail similar to the first exemplary embodiment. FIG. 26 illustrates an example of a reception mail print processing according to the second exemplary embodiment.

The reception mail print processing illustrated in FIG. 26 is similar to the reception mail print processing described in the first exemplary embodiment (see FIG. 17). Compared to the first exemplary embodiment, the reception mail print processing illustrated in FIG. 26 additionally includes device information acquisition processing (step S26002) and modifies the content of the bar code data generation processing (step S26003).

Processing performed in step S26001 is similar to the above-described processing performed in step S17001 according to the first exemplary embodiment. The mail processing control unit 5003 acquires a mail selected in the reception mail list display area 13010 from the UI control unit 5001. Next, the mail processing control unit 5003 instructs the mail data manager 5010 to acquire information relating to the selected mail from the mail information storage unit 5021.

In step S26002, the mail processing control unit 5003 instructs the device information manager 5015 to acquire a mail address allocated to the multifunction peripheral 2500a (i.e., the multifunction peripheral executing this processing) from the device information storage unit 5022. For example, the multifunction peripheral 2500a has a mail address of mfp_a@mail.co.jp.

The mail address of the multifunction peripheral 2500a is an example device identifier that can identify a multifunction peripheral (image forming apparatus).

In step S26003, the mail processing control unit 5003 generates a character string as a combination of the “Message-ID” (mail header information) acquired in step S26001 and the mail address (mfp_a@mail.co.jp) of the multifunction peripheral 2500a acquired in step S26002. Furthermore, the mail processing control unit 5003 generates image data of a two-dimensional bar code based on the generated character string.

For example, when the Message-ID is <20070301095539.62CC.t.kimura@canon.co.jp>, the mail processing control unit 5003 generates a character string <20070301095539.62CC.t.kimura@canon.co.jp>,mfp_a@mail.co.jp by connecting the mail address of the multifunction peripheral 2500a to the Message-ID. The connection order of the “Message-ID” and the mail address can be reversed. A joint character (or character string) connecting the “Message-ID” and the mail address can be changed. In any case, the connected character string needs to be later separated into the Message-ID and the mail address. Any other method can be used to combine the Message-ID and the mail address if the connected character string can be later separated into the Message-ID and the mail address.

An exemplary embodiment uses a half size of character “,” (comma) to connect the “Message-ID” and the “mail address” in this order. Using “,” (comma) for a mail address is prohibited. Therefore, “,” (comma) is regarded as a division point where the character string can be separated into two parts (“Message-ID” and “mail address”).

As described above, the processing performed in step S26003 is different from the processing performed in step S17002 only in that a combination of the “Message-ID” and the mail address of the multifunction peripheral presently operating is used to generate a two-dimensional bar code image. However, processing performed in steps S26004 to S26010 is similar to the above-described processing performed in steps S17003 to S17009 and is therefore not described below.

The reception mail print processing illustrated in FIG. 26 can generate an application form similar to those illustrated in FIGS. 19 and 20 according to the first exemplary embodiment. The application form generated by the processing illustrated in FIG. 26 is different from the first exemplary embodiment only in that a two-dimensional bar code image containing information relating to a mail address of the multifunction peripheral is printed on a paper.

In the mail sending procedure 7030 of FIG. 25, the approver 7005 activates the multifunction peripheral 2500b (i.e., the multifunction peripheral different from the multifunction peripheral 2500a having received the applicant's mail) to return the paper completed by the approver 7005 to the applicant 7001.

Similar to the first exemplary embodiment, the approver 7005 sets the auto-reply button 9010 to an enabled state on the sending setting screen 9000 illustrated in FIG. 9 and presses the start key 6003 while confirming the mail sending operation screen 8000 illustrated in FIG. 8 to start the mail auto-reply processing.

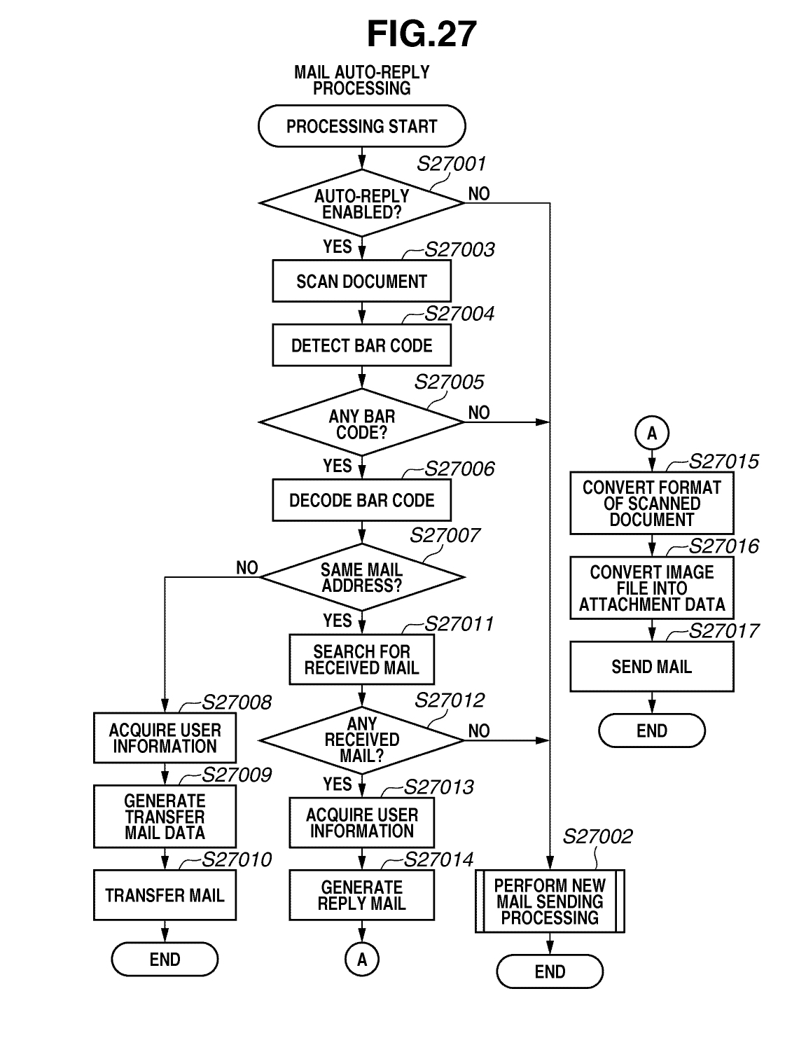

FIG. 27 is a flowchart illustrating an example of a mail auto-reply processing according to the second exemplary embodiment, which is similar to the mail auto-reply processing according to the first exemplary embodiment (see FIG. 23).

The mail auto-reply processing illustrated in FIG. 27 includes additional processing for checking a mail address of the multifunction peripheral (see step S27007) and processing performed when the mail address is different (see 27008 to 27010).

Processing performed in steps S27001 to 27006 is similar to the above-described processing performed in steps S23001 to S23006 illustrated in FIG. 23 and is therefore not described below.

In step S27007, the mail processing control unit 5003 decodes the two-dimensional bar code and separates the acquired character string into the “Message-ID” and the mail address. In the exemplary embodiment, the mail processing control unit 5003 divides the character string into two parts separable at “,” (comma). Next, the mail processing control unit 5003 instructs the device information manager 5015 to acquire a mail address allocated to the multifunction peripheral 2500b (i.e., the multifunction peripheral executing this processing) from the device information storage unit 5022. The mail processing control unit 5003 compares the acquired mail address with the separated mail address. This comparison can be referred to as “device identifier comparison.”

If the compared mail addresses are identical with each other (YES in step S27007), the mail processing control unit 5003 determines that the multifunction peripheral currently performing mail sending processing is identical to the multifunction peripheral having received/printed the applicant's mail. In this case, the processing proceeds to step S27011. Processing performed in and after step S27011 is similar to the above-described processing performed in and after steps S23007 in FIG. 23 according to the first exemplary embodiment and is therefore not described below.

If the compared mail addresses are not identical with each other (NO in step S27007), the mail processing control unit 5003 determines that the multifunction peripheral currently performing the mail sending processing is different from the multifunction peripheral having received/printed the applicant's mail. In other words, information relating to the original mail having been received by the approver 7001 is not present in the multifunction peripheral currently performing the mail sending processing. Therefore, the processing proceeds to step S27008 to transfer the scanned application form to the multifunction peripheral having received the original mail.

In step 27008, the mail processing control unit 5003 instructs the user manager 5014 illustrated in FIG. 24 to acquire, from the user information storage unit 5021, mail account information (registered in a mail server) of the approver 7005 currently logging-on the multifunction peripheral and store the acquired mail account information in the RAM 3002.

In step S27009, the mail processing control unit 5003 generates transfer mail data with image scanned in step S27003. In this case, the mail processing control unit 5003 generates a new mail while designating nothing in the “In-Reply-To” and “References” fields as header information. The mail processing control unit 5003 converts the image data obtained in step S27003 into image data having a file format designated by the file format button 8021 on the mail sending operation screen 8000. Furthermore, the mail processing control unit 5003 converts the obtained image file into a file having a code format attachable to an electronic mail. More specifically, the mail processing control unit 5003 encodes the image data obtained in step S27003 into Base 64 data according to the regulations of MIME. The mail processing control unit 5003 sets a mail address extracted from the character string decoded from the two-dimensional bar code in step S27007 to the “To” field.

In step S27010, the mail processing control unit 5003 sends a mail with the generated mail data attached. The mail processing control unit 5003 accesses the mail server referring to the account information acquired in step S27008 and sends the mail generated in step S27009 to the mail server. The mail sending processing performed in step S27010 corresponds to a mail sending procedure 25005 (i.e., processing for transferring mail data from the multifunction peripheral 2500b to the multifunction peripheral 2500a) illustrated in FIG. 25.

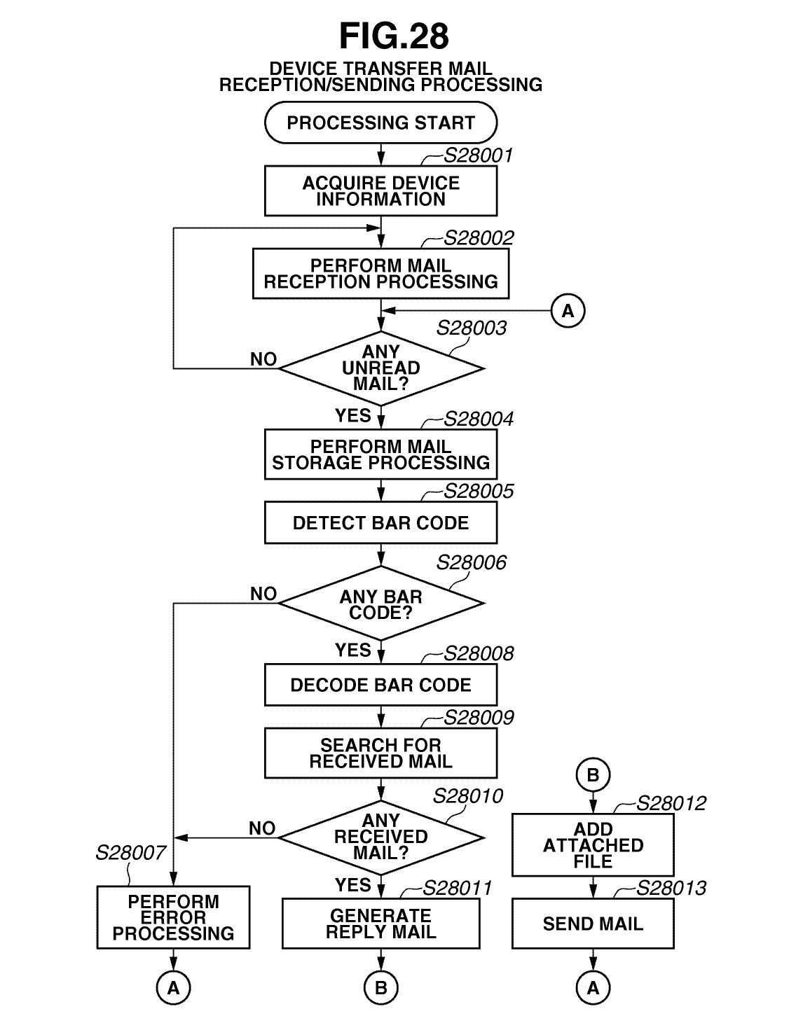

FIG. 28 is a flowchart illustrating an example of a device transfer mail reception/sending processing performed by the device mail processing control unit 5030 illustrated in FIG. 24. The device mail processing control unit 5030, loadable from the HUD 3004 in response to startup of the multifunction peripheral, starts and repetitively executes the device transfer mail reception/sending processing.

In step S28001, the device mail processing control unit 5030 instructs the device information manager 5015 to acquire a mail address allocated to the multifunction peripheral and mail account information (i.e., information required to access a mail server) from the device information storage unit 5022. The RAM 3002 stores the acquired information.

In step S28002, the device mail processing control unit 5030 performs mail reception processing for receiving a mail addressed to the multifunction peripheral based on the mail account information acquired in step S28001. The mail received in step S28002 is the mail sent in the above-described mail auto-reply processing (see step S27010 in FIG. 27).

In step S28003, the device mail processing control unit 5030 checks the presence of any unread mail in the reception processing performed in step S28002. If there is not any unread mail (NO in step S28003), the processing returns to step S28002 in which the device mail processing control unit 5030 repeats the mail reception processing. If there is an unread mail (YES in step S28003), the processing proceeds to step S28004.

In step S28004, the device mail processing control unit 5030 starts processing the unread mail one by one. First, the device mail processing control unit 5030 downloads mail information of the unread mail from the mail server. The HDD 3004 stores the downloaded mail information. The mail processed in step S28004 is the mail containing the scanned application form completed by the approver 7005 and sent from the multifunction peripheral 2500b scanning the completed form in the mail sending procedure 25005 in FIG. 25. An address of the multifunction peripheral 2500a having received/printed the applicant's mail is embedded in the two-dimensional bar code on the application form completed by the approver 7005. Therefore, the multifunction peripheral 2500b can transfer the mail to the multifunction peripheral 2500a. Therefore, the attached file of the mail received from the multifunction peripheral 2500b contains the image data of the application form printed by the multifunction peripheral 2500a.

In step S28005, the device mail processing control unit 5030 instructs the bar code manager 5011 to extract attached file information from the mail stored in the HDD 3004 (see step S28004) and decode (convert) the extracted information into image data. The device mail processing control unit 5030 instructs the bar code manager 5011 to check the presence of any two-dimensional bar code in the image data. In step S28006, the device mail processing control unit 5030 determines whether a two-dimensional bar code is present at a predetermined position.

As described in the mail auto-reply processing illustrated in FIG. 27, the above-described mail reception is processing for receiving a mail addressed to a mail address embedded in a two-dimensional bar code contained in image data of an attached file. If no two-dimensional bar code is detected (NO in step S28006), the processing proceeds to step S28007 in which the device mail processing control unit 5030 performs error processing for notifying reception of a mail not related to this processing.

The device mail processing control unit 5030 completes the error processing (step S28007) by outputting an error log. Then, the processing returns to step S28003 in which the device mail processing control unit 5030 checks the presence of any other unread mail.

If a two-dimensional bar code is detected (YES in step S28006), the processing proceeds to step S28008. In step S28008, the device mail processing control unit 5030 instructs the bar code manager 5011 to perform decoding processing for extracting an embedded character string. After completing the extraction of a character string, the device mail processing control unit 5030 separates the character string into a “Message-ID” and a “mail address.” In the exemplary embodiment, as described above, the device mail processing control unit 5030 divides the character string by a joint character “,” (comma).

In step S28009, the device mail processing control unit 5030 instructs the mail data manager 5010 to search the mail information storage unit 5020 for a mail corresponding to the “Message-ID” extracted from the bar code in step S28008. In step S28010, the device mail processing control unit 5030 determines whether a mail corresponding to the “Message-ID” is present in the mail information storage unit 5020.

If the mail information storage unit 5020 does not store any mail corresponding to the Message-ID (NO in step S28010), the device mail processing control unit 5030 determines that the mail received in the mail sending procedure 7010 in FIG. 25 is already deleted from the multifunction peripheral 2500a. Therefore, the device mail processing control unit 5030 cannot generate a reply mail. The processing proceeds to step S28007 in which the device mail processing control unit 5030 performs the error processing as described above. The device mail processing control unit 5030 completes the error processing (step S28007) by outputting an error log. Then, the processing returns to step S28003 in which the device mail processing control unit 5030 checks the presence of any other unread mail.

If the mail information storage unit 5020 stores a mail corresponding to the Message-ID (YES in step S28010), the processing proceeds to step S28011 in which the device mail processing control unit 5030 performs reply mail generation processing.

The mail acquired in step S28009 is the mail printed using the multifunction peripheral 2500a according to the reception mail print processing illustrated in FIG. 26 when the approver 7005 received the mail using the multifunction peripheral 2500a. Information relating to this mail is referred to as “parent mail information.”

In step S28011, the device mail processing control unit 5030 performs reply mail generation processing for returning a reply mail to the applicant 7001. More specifically, the device mail processing control unit 5030 performs the following processing m) to s) according to the regulations of RFC2822.

m) The device mail processing control unit 5030 generates a Message-ID that can identify a reply mail and sets the generated Message-ID as header information of the mail.
n) The device mail processing control unit 5030 sets the Message-ID (header information) of the parent mail information to the “In-Reply-To” field of the reply mail.
o) The device mail processing control unit 5030 adds the Message-ID (header information) of the parent mail information to the tail of the “References” (header information) of the parent mail information and sets the added information to the “References” (header information) field of the reply mail.
p) The device mail processing control unit 5030 sets an address in “Reply-To” of the parent mail information or in “From”, if not designated in “Reply-To”, to the “To” field of the reply mail.
q) The device mail processing control unit 5030 sets an address designated in “Cc” of the parent mail information to the “Cc” field of the reply mail.
r) The device mail processing control unit 5030 puts “Re:” to the head of “Subject” of the parent mail information and sets it to the “Subject” field of the reply mail.
s) The device mail processing control unit 5030 sets the mail body of the parent mail information to the body of the reply mail.

Through the above-described processing m) to o), the reply mail can be defined as a child mail of the mail sent from the applicant 7001 (see 7010 in FIG. 25).

In the above-described processing p) to s), the device mail processing control unit 5030 sets the address and the “Subject” of the reply mail referring to the information of the original mail designated in the mail sending procedure 7010 in FIG. 25. In particular, the processing p) and q) relating to the address of the reply mail is important.

In step S28012, the device mail processing control unit 5030 acquires attachment file data from the mail data stored in the HDD 3004 in step S28004 and adds the acquired attachment file data to the reply mail.

In step S28013, the device mail processing control unit 5030 sends the reply mail to the multifunction peripheral 2500a referring to the mail account information acquired in step S28001.

When the device mail processing control unit 5030 completes the processing of step S28013, the processing returns to step S28003 in which the device mail processing control unit 5030 checks the presence of any other unread mail.

In this manner, the device mail processing control unit 5030 successively performs transfer processing for reception mails.

Hence, the approver 7005 can easily send a mail to the applicant 7001 even in the above-described main sending procedures (see FIG. 25) in which the approver 7005 operates one multifunction peripheral 2500a to receive/print an applicant's mail and operates another multifunction peripheral 2500b to send a reply mail containing an application form completed by the approver 7005.

In the second exemplary embodiment, a two-dimensional bar code printed on an application form contains a mail address allocated the device in addition to a Message-ID. Therefore, the amount of information stored in the two-dimensional bar code is slightly greater that that described in the first exemplary embodiment. However, since the information contained in the two-dimensional bar code is limited to a combination of only one Message-ID and only one mail address, the entire information of the reply mail is only slightly increased.

The present invention can be embodied as a system, an apparatus, a method, a program or a storage medium. More specifically, the present invention can be applied to a system including a plurality of devices or can be applied to a single apparatus.

Software program code for realizing the functions of the above-described exemplary embodiments can be supplied directly, or from a remote device, to a system or an apparatus. A computer (or CPU or micro-processing unit (MPU)) in the system or the apparatus can execute the program to operate devices to realize the functions of the above-described exemplary embodiments. Accordingly, the present invention encompasses the program code installable on a computer when the computer can realize the functions or processes of the exemplary embodiments described with reference to the flowcharts.

In this case, the program code itself can realize the functions of the exemplary embodiments. The equivalents of programs are usable if they possess comparable functions. Furthermore, the present invention encompasses supplying program code to a computer with a storage (or recording) medium storing the program code. In this case, the type of program can be any one of object code, interpreter program, and OS script data. A storage medium supplying the program can be selected from any one of a floppy disk, a hard disk, an optical disk, a magneto-optical (MO) disk, a compact disc-ROM (CD-ROM), a CD-recordable (CD-R), a CD-rewritable (CD-RW), a magnetic tape, a nonvolatile memory card, a ROM, and a DVD (DVD-ROM, DVD-R).

The method for supplying the program includes accessing a web site on the Internet using the browsing function of a client computer, when the web site allows each user to download the computer program of the present invention, or compressed files of the programs having automatic installing functions, to a hard disk or other recording medium of the user. Furthermore, the program code constituting the programs of the present invention is dividable into a plurality of files so that respective files are downloadable from different web sites. Namely, the present invention encompasses World Wide Web (WWW) servers that allow numerous users to download the program files so that their computers can realize the functions or processes of the present invention.

Enciphering the programs of the present invention and storing the enciphered programs on a CD-ROM or comparable recording medium is an exemplary method when the programs of the present invention are distributable to the users. The authorized users (i.e., users satisfying predetermined conditions) are allowed to download key information from a page on the Internet. The users can decipher the programs with the obtained key information and can install the programs on their computers. When the computer reads and executes the installed programs, the computer can realize the functions of the above-described exemplary embodiments.

Moreover, an operating system (OS) or other application software running on a computer can execute part or all of actual processing based on instructions of the programs. Additionally, the program code read out of a storage medium can be written into a memory of a function expansion board inserted in a computer or into a memory of a function expansion unit connected to the computer. In this case, based on an instruction of the program, a CPU provided on the function expansion board or the function expansion unit can execute part or all of the processing to realize the functions of the above-described exemplary embodiments.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

What is claimed is:

1. An image forming apparatus comprising:
a mail reception unit configured to access a mail server based on designated mail account information and perform reception of an electronic mail;
a mail management unit configured to store the electronic mail received by the mail reception unit in a readable state;
a reading unit configured to read a document image and generate document image data;
a detection unit configured to detect electronic mail identification information and a device identifier contained in the document image data;
a device identifier comparing unit configured to compare the device identifier detected by the detection unit with the device identifier allocated to the image forming apparatus;
a retrieval unit configured to search the stored electronic mail in the mail management unit for an electronic mail corresponding to the electronic mail identification information if the device identifier detected by the detection unit corresponds to the device identifier allocated to the image forming apparatus;
a printing unit configured to perform printing of the electronic mail stored in the mail management unit; and
a mail attaching and sending unit configured to send an electronic mail containing the read document image data to an image forming apparatus having the detected device identifier if the device identifier detected by the detection unit does not correspond to the device identifier allocated to the image forming apparatus.

2. The image forming apparatus according to claim 1, wherein the printing unit is configured to perform printing by adding the electronic mail identification information to a print image of the electronic mail.

3. The image forming apparatus according to claim 1, further comprising:
a mail sending unit configured to extract a Message-ID from header information of the electronic mail stored in the mail management unit, generate a new mail including the extracted Message-ID in an In-Reply-To or References field, and send the generated mail as a reply mail.

4. A method for controlling an image forming apparatus, the method comprising:
accessing a mail server based on designated mail account information and performing reception of an electronic mail;
storing the received electronic mail in a readable state;
reading a document image and generating document image data;
detecting electronic mail identification information and a device identifier contained in the document image data;
comparing the detected device identifier with the device identifier allocated to the image forming apparatus;
searching the stored electronic mail for an electronic mail corresponding to the electronic mail identification information if the detected device identifier corresponds to the device identifier allocated to the image forming apparatus;
performing printing of the stored electronic mail; and
sending an electronic mail containing the read document image data to an image forming apparatus having the detected device identifier if the detected device identifier does not correspond to the device identifier allocated to the image forming apparatus.

5. The method according to claim 4, wherein performing printing further includes performing printing by adding the electronic mail identification information to a print image of the electronic mail.

6. The method according to claim 4, further comprising
extracting a Message-ID from header information of the stored electronic mail, generating a new mail including the extracted Message-ID in an In-Reply-To or References field, and sending the generated mail as a reply mail.

7. A non-transitory computer-readable storage medium storing a computer-executable program causing a computer to execute the method according to claim 4.
